(19) United States
(12) Patent Application Publication
(10) Pub. No.: US 2021/0044191 A1
(43) Pub. Date: Feb. 11, 2021

(54) LINEAR MACHINE

(71) Applicant: Linear Labs, Inc., Fort Worth, TX (US)

(72) Inventors: Fred E. Hunstable, Granbury, TX (US); Abla Hariri, Fort Worth, TX (US); Erik Hatch, Frisco, TX (US)

(21) Appl. No.: 16/988,494

(22) Filed: Aug. 7, 2020

Related U.S. Application Data
(60) Provisional application No. 62/883,781, filed on Aug. 7, 2019.
(60) Provisional application No. 62/976,955, filed on Feb. 14, 2020.

(51) Int. Cl. H02K 35/02; H02K 1/20; B60G 17/06

(52) U.S. Cl. CPC H02K 35/02; B60G 2202/20; B60G 17/06; H02K 1/20

(57) ABSTRACT

Disclosed are various embodiments for a linear machine having a magnetic torque tunnel stator comprising an outer core assembly formed of a plurality of exterior permanent magnets couple to the inside retaining wall of a tube, where adjacent exterior permanent magnets are separated by an exterior ring spacer of ferromagnetic material, and an interior core assembly having a plurality of interior permanent magnets coupled to the outside wall of a central core, where adjacent interior permanent magnets are separated by an interior ring spacer of ferromagnetic material, the magnetic poles of the exterior and interior permanent magnets configured to face each other, and a coil winding assembly armature configured to be slidably positioned within the magnetic torque tunnel of the stator.

### RELATED APPLICATIONS

This application claims priority to U.S application No. 62/883,781 entitled “A LINEAR GENERATOR/MOTOR” filed Aug. 7, 2019 and U.S application No. 62/976,955 entitled “A LINEAR GENERATOR/MOTOR” filed Feb. 14, 2020 the disclosures of which are hereby incorporated by reference for all purposes.

### TECHNICAL FIELD

The invention relates in general to power generation methods, linear motors, and in particular to an improved method for generating electrical power using linear power generators.

### BACKGROUND INFORMATION

Generators are usually based on the principle of electromagnetic induction, which was discovered by Michael Faraday in 1831. Faraday discovered that when an electrical conducting material, such as coils of copper wire, are moved through a magnetic field, or vice versa, an electric current will begin to flow through that moving conducting material. In this situation, the coils of wire are called the armature, because they are moving with respect to the stationary magnets, which are called the stator. Typically, the moving component is called the rotor or armature and the stationary components are called the stator. The power generated is a function of flux strength, conductor size, number of pole pieces, and motor speed in revolutions per minute (RPM).

Linear generators, in contrast, usually have a magnetic core moving through coils of wire. As the magnetic core passes through the coils, electrical current is produced. In this situation, the magnetic core is the armature because it moves relative to the coils, which are now called the stators.

Typically, some energy source is used to provide power to move the armature with respect to the stator. Typical sources of mechanical power are a reciprocating or turbine steam engine, water falling through a turbine or waterwheel, an internal combustion engine, a wind turbine, or even a hand crank. As energy becomes scarcer and more expensive, what is needed are efficient motors and generators to reduce energy consumption and hence reduce costs. Further, not all sources of mechanical power are readily available in all areas of the world, so there is also a need for methods and mechanisms that produce electrical power from readily obtainable power sources such as wind and waves.

### SUMMARY

In response to this and other problems, disclosed are various embodiments for a linear machine having a magnetic torque tunnel stator comprising an outer core assembly formed of a plurality of exterior permanent magnets couple to the inside retaining wall of a tube, where adjacent exterior permanent magnets are separated by an exterior ring spacer of ferromagnetic material, and an interior core assembly having a plurality of interior permanent magnets coupled to the outside wall of a central core, where adjacent interior permanent magnets are separated by an interior ring spacer of ferromagnetic material, the magnetic poles of the exterior and interior permanent magnets configured to face each other, and a coil winding assembly armature configured to be slidably positioned within the magnetic torque tunnel of the stator.

These and other features, and advantages, will be more clearly understood from the following detailed description taken in conjunction with the accompanying drawings.

### BRIEF DESCRIPTION OF THE DRAWINGS

FIG. 1A illustrates a section or a partial section of one embodiment of a coil assembly of a linear generator/motor.

FIG. 1B illustrates a detailed portion of two “sections” of the coil assembly.

FIG. 2A illustrates a section or partial sectional view of a magnetic assembly concentrically aligned with the axial axis.

FIG. 2B is a detailed section view of a portion of the magnetic assembly illustrating two “sections” corresponding to the coil assembly sections illustrated in FIG. 1B.

FIG. 3 is a section view of the linear generator/motor illustrating a coil assembly positioned within the magnetic assembly.

FIG. 4 is a detailed partial sectional isometric view of a portion of the linear generator/motor of FIG. 3.

FIG. 5 is a detailed sectional view illustrating specific components of a portion of the magnetic assembly of the linear generator/motor of FIG. 2A.

FIG. 6 illustrates input waveform(s) used for the mathematical modeling of the linear generator.

FIG. 7A illustrates a full-wave three-phase rectification circuit that may be user to convert a 3-phase Alternating Current (AC) output of a linear generator to a Direct Current (DC) regulated Voltage.

FIG. 7B illustrates a 3-phase bridge rectifier connected to a 3-phase 3 wire AC supply.

FIG. 7C illustrates the corresponding 3-phase AC supply input sine waves for the circuit of FIG. 7B.

FIG. 7D illustrates the corresponding six half-waves of the rectified DC output for the circuit of FIG. 7B.

FIG. 8 illustrates various topology changes and parameter variations that were simulated during the performance evaluation of the linear generator.

FIG. 9A illustrates surface magnetic flux density and corresponding simulated power output of a single regenerative shock absorber.

FIG. 9B illustrates an application of a regenerative shock absorber.

FIG. 10A illustrates typical phase voltage and phase current waveforms for a 3-phase regenerative shock absorber.

FIG. 10B illustrates the corresponding stimulus input for regenerative shock absorber of FIG. 10A and the corresponding instantaneous rms power output.

FIG. 11 illustrates the root mean (rms) power output of the regenerative shock absorber for higher excitation frequencies and larger stroke amplitudes.

FIG. 12A illustrates an array of eight magnets having the same orientation and their stand-alone flux field.

FIG. 12B illustrates the corresponding stand-alone flux field of a Halbach array having eight permanent magnets.

FIG. 13 is a cross section view of two different embodiments of the linear generator illustrating the relationship between a repeating Halbach array of permanent magnets and the corresponding coils of a 3-phase coil winding assembly.

FIG. 14 illustrates a detailed cross section view of the linear generator of FIG. 13 including the region of the Halbach arrays the extend beyond the length of the coil winding assembly.

FIG. 15 illustrates a cross section view of the linear generator of FIG. 13 including an end cap having a Halbach array of permanent magnets.

FIG. 16 illustrates a cross section view of a linear generator that includes a plurality of magnets within an exterior retaining wall having their similar magnetic poles facing inwards towards the longitudinal axis and separated by ring spacers of ferrous material.

FIG. 17 illustrates a cross section view of the linear generator of FIG. 16 including an end cap having a plurality of magnets with their similar magnetic poles facing inwards towards the interior of the linear generator and separated by spaces of ferrous material.

FIG. 18 illustrates the stand-alone flux field of a portion of the linear generator of FIG. 16.

FIG. 19, illustrates in tabular form various parameters that affect the hypothetical root mean square (rms) power output of the proposed linear generator when used as a regenerative shock absorber.

FIG. 20A is an isometric view illustrating eddy currents in non-laminated yoke assembly.

FIG. 20B is an isometric view illustrating eddy currents in a laminated yoke assembly.

FIG. 21A is a perspective view of the yoke assembly.

FIG. 21B is a perspective section view of the yoke assembly of FIG. 21A.

FIG. 22 is a perspective view of the yoke assembly coupled to the coil winding assembly having a first end cap and a second end cap with the magnet segment assembly removed.

FIG. 23A is a perspective view of the first end cap of the yoke assembly of FIG. 22.

FIG. 23B is a perspective view of the second end cap of the yoke assembly of FIG. 22.

FIG. 24A illustrates the yoke assembly and coil winding assembly in perspective view.

FIG. 24B illustrates a perspective section view of FIG. 24A further including the support frame and the magnet segment assembly.

FIG. 25A is a perspective view of the magnet segment assembly and support frame.

FIG. 25B is a perspective section view of the magnet segment assembly and support frame of FIG. 25A.

### DETAILED DESCRIPTION

Specific examples of components, signals, messages, protocols, and arrangements are described below to simplify the present disclosure. These are, of course, merely examples and are not intended to limit the invention from that described in the claims. Well-known elements are presented without detailed description in order not to obscure the present invention in unnecessary detail. For the most part, details unnecessary to obtain a complete understanding of the present invention have been omitted inasmuch as such details are within the skills of persons of ordinary skill in the relevant art. Details regarding control circuitry or mechanisms used to control the rotation of the various elements described herein are omitted, as such control circuits are within the skills of persons of ordinary skill in the relevant art.

When directions, such as upper, lower, top, bottom, clockwise, counterclockwise, are discussed in this disclosure, such directions are meant to only supply reference directions for the illustrated figures and for orientation of components in the figures. The directions should not be read to imply actual directions used in any resulting invention or actual use. Under no circumstances, should such directions be read to limit or impart any meaning into the claims.

### Clarification of Terms

The flow of current through a conductor creates a magnetic field. When a current carrying conductor is placed in a magnetic field the current carrying conductor will experience a force. The force that the current carrying conductor experiences is proportional to the current in the wire and the strength of the magnet field that it is placed in. Further, the force that the current carrying conductor experiences will be greatest when the magnetic field is perpendicular to the conductor. For the purposes of this application “flux current” is defined as the rate of current flow through a given conductor cross-sectional area. In some embodiments described herein the source of the magnetic field may be a current flowing in individual coils of a motor winding. In other embodiments, the source of the magnetic field may be a permanent magnet. The magnetic field associated with the permanent magnetic may be visualized as comprising of a plurality of directional magnetic flux lines surrounding the permanent magnet. The magnetic flux lines, often denoted as ϕ, or ϕ_{B} are conventionally taken as positively directed from an N pole to an S pole of the permanent magnet. The flux density, often written in bold type as B, in a sectional area A of the magnetic field surrounding the permanent magnet is defined as the magnetic flux ϕ divided by the area A and is a vector quantity.

For the purposes of this application permeability is a measure of the ability of a material to support the formation of magnetic field within the material. That is, permeability is the degree of magnetization that the material will obtain in response to an applied magnetic field.

For the purposes of this application an “inductor” is defined as an electrical component that stores energy in a magnetic field when electric current flows through the inductor. Inductors normally consist of an insulated conducting wire wound into a coil around a core of ferromagnetic material like iron. The magnetizing field from the coil will induce magnetization in the ferromagnetic material thereby increasing the magnetic flux. The high permeability of the ferromagnetic core significantly increases the inductance of the coil. In some embodiments described herein the permeability of the ferromagnetic core may increase the inductance of the coil by a factor of about one thousand or more. The inductance of a circuit depends on the geometry of the current path and the magnetic permeability of nearby materials. For instance, winding a copper wire into a coil increases the number of times the magnetic flux lines link the circuit thereby increasing the field and thus the inductance of the circuit. That is, the more coils the higher the inductance. The inductance also depends on other factors, such as, the shape of the coil, the separation of the coils, and the like. Flux linkage occurs when the magnetic flux lines pass through the coil of wire and its magnitude is determined by the number of coils and the flux density.

For the purposes of this application the term “torque-producing current” is the current required to generate motor torque. In a permanent magnet machine, the torque-producing current makes up most of the current draw.

When the current flowing through the inductor changes, the time-varying magnetic field induces an Electromotive Force (emf) (voltage) in the conductor, described by Faraday's law of induction . According to Lenz's law, the induced voltage has a polarity which opposes the change in current that created it. As a result, inductors oppose any changes in current through them. For the purposes of this application the term “back electromotive force” or “back emf” is the voltage that occurs in electric motors when there is a relative motion between the stator and the magnetic field of the armature windings. The geometric properties of the armature will determine the shape of the back emf waveform. The back emf waveforms may be sinusoidal, trapezoidal, triangular, or a combination thereof. The back emf voltage will rise linearly with speed and is a substantial factor in determining maximum operating speed of an electric motor.

For purposes of this application the term “back iron” may refer to iron or any ferrous-magnetic compound or alloy, such as stainless steel, any nickel or cobalt alloy, electrical steel, laminated steel, laminated silicon steel, or any laminated metal comprising laminated sheets of such material, or a sintered specialty magnetic powder. The back iron may form part of a back-iron circuit, which while theoretically optional serves to strengthen magnetic elements and constrain the magnetic circuit to limit reluctance by removing or reducing the return air path.

### The Coil Winding Assembly:

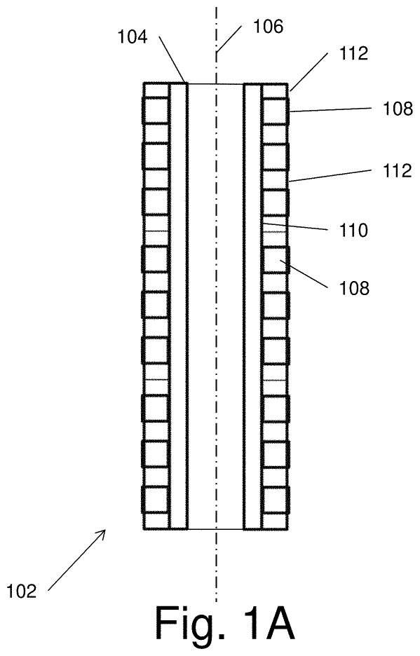

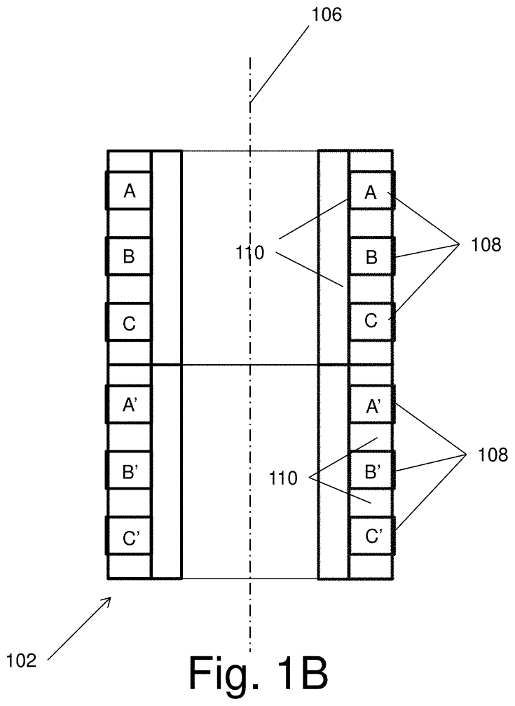

Turning now to FIG. 1A, there is presented a section or a partial section of one embodiment of a coil winding assembly 102 which will be part of a linear generator/motor 100 described in detail below.

In the illustrated embodiment, the coil winding assembly 102 comprises a coil assembly cylinder or central core 104 positioned about a central longitudinal axis 106. A plurality of donut shaped or cylindrical coils 108 are coupled to the outside surface 110 of the central core 104. A plurality of coil assembly spacers 112 are axially positioned between the coils 108.

In some embodiments, the coil winding assembly 102 may be potted with a potting compound, which may be an epoxy material. In certain embodiments, to maintain the generated torque and/or power of the linear motor 100 the individual coils in the coil winding assembly 102 may be selectively energized or activated by way of a high-power electronic switching system or linear motor controller which selectively and operatively provides electrical current to the individual coils 108 in a conventional manner. In order to maintain the linear displacement adjacent coils 108 may be powered up in turn. For instance, the linear controller may cause current to flow within the individual coil 108 when the individual coil 108 is within a magnetic tunnel segment having a North magnetic pole configuration. On the other hand when the same individual coil 108 moves into an adjacent magnetic tunnel segment with a South magnetic pole configuration, the linear motor controller causes the current within the individual coil 108 to flow in the opposite direction so that the generated magnetic force is always in same direction.

The individual coils 108 may use toroidal winding without end windings and in some embodiments be connected to each other in series. In other embodiments, a three-phase winding may be used where adjacent coils 108 are connected together to form a branch of each phase. For instance, two adjacent coils 108 may be phase A coils, the next two adjacent coils 108 may be phase B coils, and the next two adjacent coils 108 may be phase C coils. This three-phase configuration would then repeat for all individual coils 108 within the coil winding assembly 102. When the coils 108 are energized, the three-phase winding can produce a moving magnetic field in the air gap around the coil winding assembly 102. The moving magnetic field interacts with the magnetic field generated by the toroidal magnetic tunnel producing torque and relative movement between the coil winding assembly 102 and the toroidal magnetic tunnel. That is, the linear motor controller applies current to the phases in a sequence that continuously imparts torque to move the magnetic toroidal cylinder 100 in a desired direction, relative to the coil winding assembly 102, in motor mode.

In an illustrative embodiment, the central core 104 and spacers 112 may be made of a soft magnetic material, such as steel, laminated steel, iron or any material known in the art suitable for a back-iron circuit so it will act as a magnetic flux force concentrator and distribute magnetic flux to each of the armature poles. In some embodiments, the central core 104 may define one or more fluid communication passageways to allow for air or liquid cooling.

For instance, the back-iron material may be electric steel (magnetic steel) that also provides structural integrity due to its high rigidity/stiffness. In other embodiments, the back-iron circuit 804 may be made from tape wound magnetic steel laminations using high-speed tape winding techniques. ‘The tape may have an insulated coating which then separates each magnetic steel lamination so that the magnetic flux cannot migrate from one lamination to the next. In other embodiments, the tape may be coated with an insulating layer of an electrically insulating polyimide sheet, an aromatic nylon sheet, a synthetic fiber sheet, or other non-surface core plating electrically insulating sheet to further reduce the flux and current flow. This forces the magnetic flux to stay in within each magnetic steel lamination and to flow only in the plane of the magnetic steel tape. In embodiments using a Halbach array such heavy materials are not needed (although a stiff structure may be required for structural integrity—such as Polyether Ether Ketone (PEEK), aluminum or carbon fiber).

In some embodiments, individual coils 108 in the plurality of coils 108 may be made from a wire conductive material, such as copper or a similar alloy. In some instances, the winding of the linear generator may be 1 Standard Wire Gauge (SWG) copper (7.62 mm or 0.3 in). In other embodiments, concentrated windings may be used and the individual coils 108 may be essentially cylindrical, square, or rectangular in cross-sectional shape. For instance, the winding of the linear generator may be 1 SWG square copper. Square wire may enable the creation of more compact coils than the equivalent amount of round wire and therefore may deliver more power in less space. For instance, using square wire may enable the coil winding assembly 102 of the linear generator 100 to have a fill factor of about 80% percent. In another embodiment, the winding of the linear generator 100 may be aluminum wire. Aluminum wire provides a better conductivity to weight ratio than copper wire. Further, aluminum wire traditionally has a cost advantage over copper wire.

In certain embodiments, the coil windings assembly 102 of the linear generator 100 may comprise about 48 turns. In one embodiment, the coil winding assembly 102 may be configured as 3-phase and may comprise about 16 turns for each of the three phases. Although a particular number of coils 108 are illustrated in FIG. 1A, depending on the power requirements, any number of coils 108 could be used to assemble the coil winding assembly 102.

The windings of each coil 108 are configured such that they are generally perpendicular to the direction of the relative movement of the magnets or armature. In other words, the coil windings 108 are positioned such that their longitudinal sides are parallel with the central longitudinal axis 106 and their ends or axial sides are radially perpendicular to the central longitudinal axis 106. Thus, the coil windings 108 are also transverse with respect to the magnetic flux produced by the individual magnets of the stator at their interior face. Consequently, essentially the entire coil winding 108 or windings may be used to generate motion in motor mode or voltage in generator mode.

Although the central core 104, coil wing winding assembly 102, and magnetic tunnel segments are illustrated in cross-section as circular, any cross-sectional shape may be used depending on the design and performance requirement for a particular electric machine 100.

Turning now to FIG. 1 B, there is a detailed portion of two “sections” of the coil winding assembly 102. The first section comprises three coils A, B, and C of the plurality of coils 108 with two spacers 112 positioned axially between each of the three coils, respectively. The second section comprises three additional coils A′, B′, and C′ of the plurality of coils 108 with two spacers 112 positioned axially between each of the three coils, respectively. As explained above, the exact configuration, size and number of sections or coils 108 depend on the power requirements for a given application.

In certain embodiments, coil A of the first section is electrically connected to coil A′ of the second section (and additional “A” coils of following sections—which are not shown in FIG. 1 B). Similarly, coil B of the first section is electrically connected to coil B′ of the second section (and additional “B” coils of the following sections—which are not shown in FIG. 1 B). Finally, coil C of the first section is electrically connected to coil C′ of the second section (and additional “C” coils of the following sections—which are not shown in FIG. 1B).

### The Magnetic Assembly

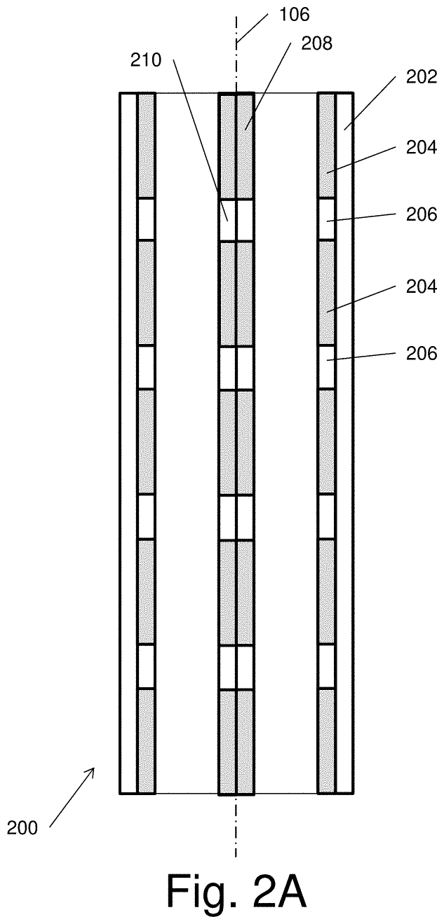

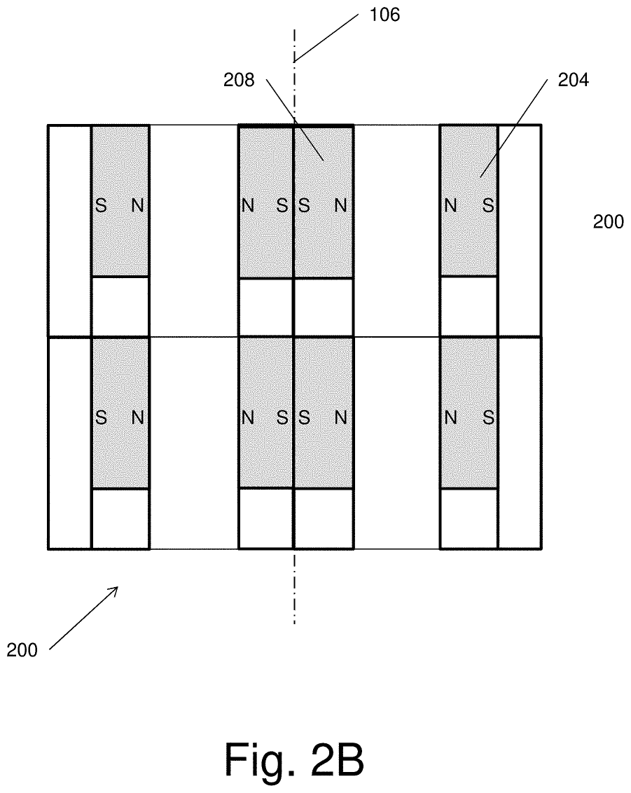

FIG. 2A illustrates a section or partial sectional view of a magnetic assembly 200 concentrically aligned with the central longitudinal axis 106. The magnetic assembly 200 comprises a magnetic assembly cylinder 202 and a plurality of external (with respect to the internal magnets 208) cylindrical or radial magnets 204 positioned adjacent to an interior face of the magnetic assembly cylinder 202. In the illustrated embodiments, there is a plurality of cylindrical interior spacers 210 longitudinally or axially positioned between each internal cylindrical magnet 208 of the plurality of internal cylindrical magnets 208.

In the illustrated embodiment, there is also a plurality of cylindrical exterior spacers 206 longitudinally or axially positioned between each external cylindrical magnet 204 of the plurality of exterior cylindrical magnets 204.

In certain embodiments, there is a plurality of interior cylindrical or radial magnets 208 positioned at the center of the magnetic assembly 200 where each interior cylindrical magnet has the same axial length and is axially aligned with a corresponding external cylindrical magnet of the plurality of magnets 204. In the illustrated embodiment, there is a plurality of cylindrical interior cylindrical spacers 210 longitudinally or axially positioned between each internal cylindrical magnet of the plurality of interior cylindrical magnets 208. Each interior cylindrical spacer 210 has the same axial length and is axially aligned with a corresponding external cylindrical spacer of the plurality of spacers 206. In an illustrative embodiment, the magnetic assembly cylinder 202 and spacers 206 and 210 may be formed from steel, iron or any material known in the art suitable for a back-iron circuit.

FIG. 2B is a detailed section view of a portion of the magnetic assembly 200 illustrating two “sections” corresponding to the coil assembly sections illustrated in FIG. 1B. FIG. 2B illustrates the orientation of the magnetic poles of the plurality of exterior cylindrical magnets 204 and the magnetic pole orientation of the interior cylindrical magnets 208. As illustrated, the magnetic pole orientation of all magnets is aligned in a radial direction with respect to the central longitudinal axis 106. Furthermore the “like” magnetic poles of the exterior magnets 204 and the like magnetic poles of the interior magnets 208 face each other. For instance, in FIG. 2B, the north magnetic pole of the exterior magnet 204 faces the north magnetic pole of the interior magnet 208 and is aligned in generally a radial direction with respect to the central longitudinal axis 106. In FIG. 2B, the north pole of the respective magnets are indicated by an “N” close to the sectional face of the magnet. Similarly, the south poles of the respective magnets are indicated by a “S” positioned close to the sectional face of the magnet. While FIG. 2B illustrates that the north magnetic poles point towards or face each other, in other embodiments, the south magnetic poles may also face each other. Such orientation is also within the scope of the invention.

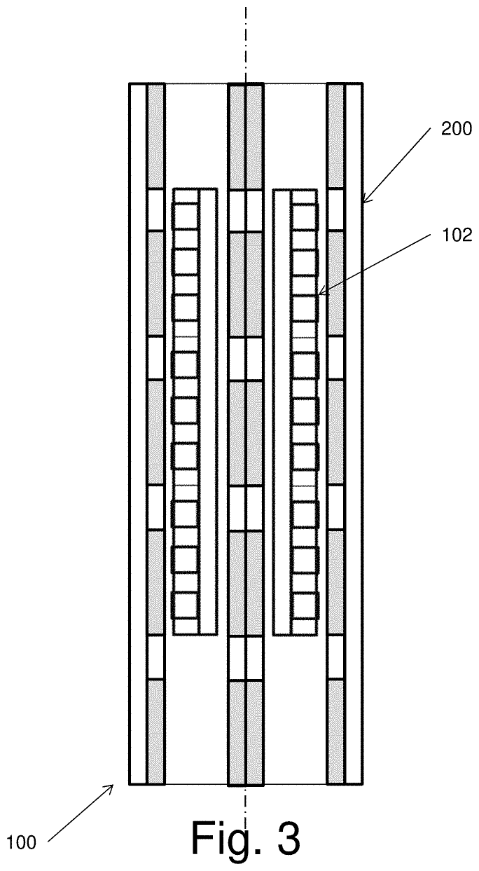

FIG. 3 is a section view of the linear generator/motor 100 illustrating the coil winding assembly 102 positioned within the magnetic assembly 200. In certain embodiments, the coil winding assembly 102 is the armature and thus moves relative to the magnetic assembly 200 which functions as the stator. In other embodiments, the coil winding assembly 102 may be the stator and the magnetic assembly 200 may be the armature. Specifically, the linear generator 100 comprises a coil assembly having at least one core element and at least one electrical coil positioned around a core element, where the coil winding assembly 102 is sized to be slidably positioned within a magnetic tube or magnetic torque tunnel.

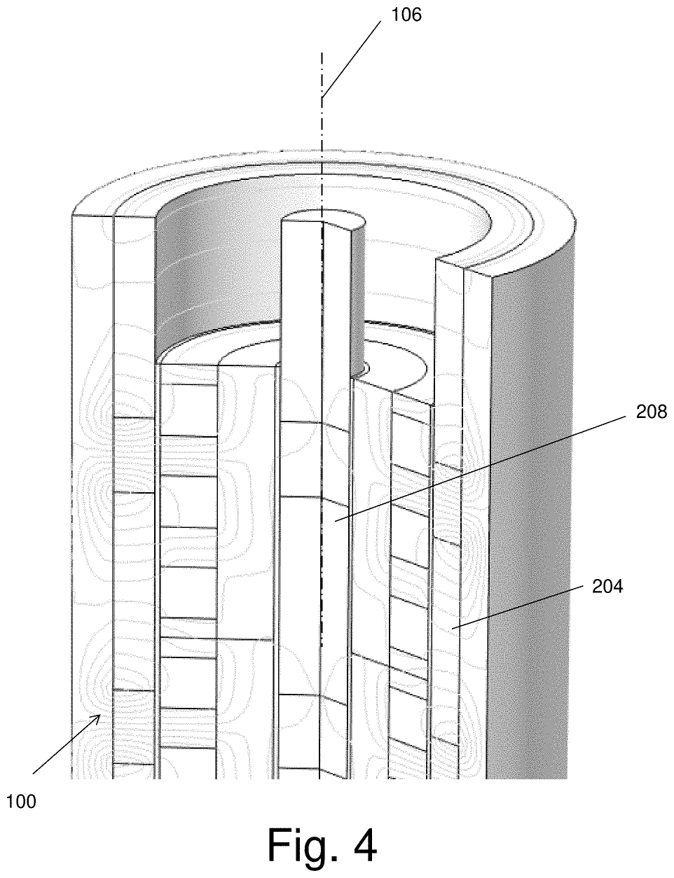

FIG. 4 is a detailed partial sectional isometric view of a portion of the linear generator/motor 100. The permanent magnets of the plurality of exterior magnets 204 and the permanent magnets of the plurality of interior magnets 208 generate magnetic forces that can be visualized as magnetic flux lines.

The flux lines will form particular patterns as the coil assembly moves relative to the magnetic assembly or vice versa. The shape, direction, and orientation of the flux lines depend on factors such as the use of an interior retaining ring, or the use of ferrous or non-ferrous metallic end plate, or an end plate consisting of magnetic assemblies oriented to force the lines of flux out of one end of the magnetic cylinder.

In certain embodiments, the coil winding assembly 102 is designed to slidably move longitudinally parallel the central longitudinal axis 106 between a top of the stroke and the bottom of the stroke. In such an embodiment, the coil winding assembly 102 would be coupled to a shaft or mechanical coupling known in the art (not shown) which is coupled to a power source (not shown), such as a shock absorber, windmill, wave buoy. In other embodiments, the magnetic assembly 200 may be coupled to the shaft or another coupling which drives the magnetic assembly between the top of the stroke and the bottom of the stroke. In such an embodiment, the magnetic assembly 200 is coupled to a power source and is the armature.

When connected to a power source, the coil winding assembly 102 moves from the top of the stroke to the bottom of the stroke and passes through a stacked plurality of magnetic flux forces in a circular area of the magnetic cylinder assembly 200 to produce electric current in the individual coils.

### Advantages of Certain Embodiments

One of the advantages of this type of configuration over conventional electric machines is that the end turns of the coils 108 are part of the “active section” or force generation section of the electric machine 100. In conventional electric machines, only the axial length of the coils produces power, the end turns of the coils do not produce power and merely add weight and copper losses. However, as explained above, the entirely of the coil 108 is effectively utilized to produce torque because of the side axial walls axial magnets. Therefore, for a given amount of copper more torque can be produced compared to a conventional electric machine.

In summation, surrounding the coils 108 with magnets creates more flux density and most of the magnetic forces generated are in the direction of motion so there is little, if any, wasted flux compared to a conventional electric motor. Further, because the forces are now all in the direction of motion more torque is generated and the configuration further minimizes vibration and noise compared to a conventional electric motor where the forces, depending on the polarity of the current in the coil may try and pull the coil downwards or push the coil upwards and therefore not in the direction of motion. Further, continuous torque and continuous power are greatly increased compared to a conventional linear motor as is the motor's torque density and power density by volume and weight.

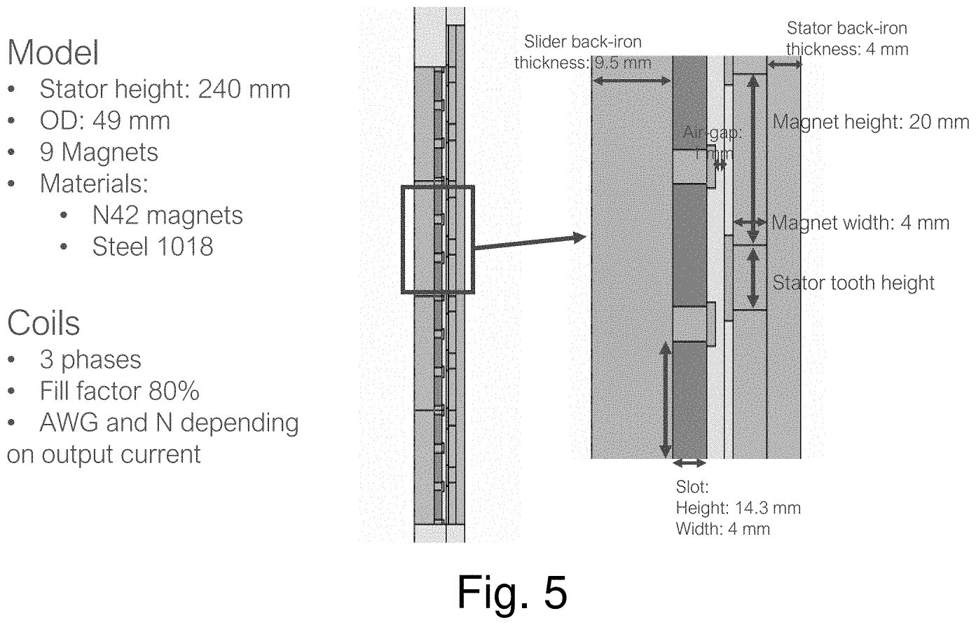

FIG. 5 is a detailed sectional view illustrating specific components of a portion of the magnetic assembly 200 of the linear generator/motor 100 of FIG. 2A. In the illustrative embodiment of FIG. 5 the magnetic material comprises N42 Neodymium Iron Boron magnets, where N42 refers to the grade of the Neodymium magnetic material. Specifically, N42 refers to neodymium magnets having a Maximum Energy Product (BHmax) of 42 Mega Gauss Oersted (MGOe) and represents the strongest point on the magnet's Demagnetization Curve. Generally speaking, the higher the grade of the magnetic material, the stronger the magnet. Currently, the highest grade of neodymium magnet available is N55 and the lowest grade is N35. and the back-iron circuit includes Steel 1018. FIG. 5 further illustrates a back-iron circuit including steel 1018, which is a general-purpose mild low carbon steel having good ductility, toughness, and strength properties.

In some embodiments, the magnetic assembly 200 may comprise a plurality of Neodymium Iron Boron Magnets having a BHmax between about 35 MGOe and about 55 MGOe. In certain embodiments, the plurality of Neodymium Iron Boron Magnets may include Neodymium Iron Boron Magnets having a BHmax of about 42 MGOe.

Rotary electric generators induce an electromagnetic field by rotating a coil in a magnetic field and the magnitude of the electromagnetic field is proportional to the generator's angular velocity ω. Linear electric generators induce an electromagnetic field by moving a coil through a magnetic field and the magnitude of the electromagnetic field is proportional to the generator's linear velocity v(t).

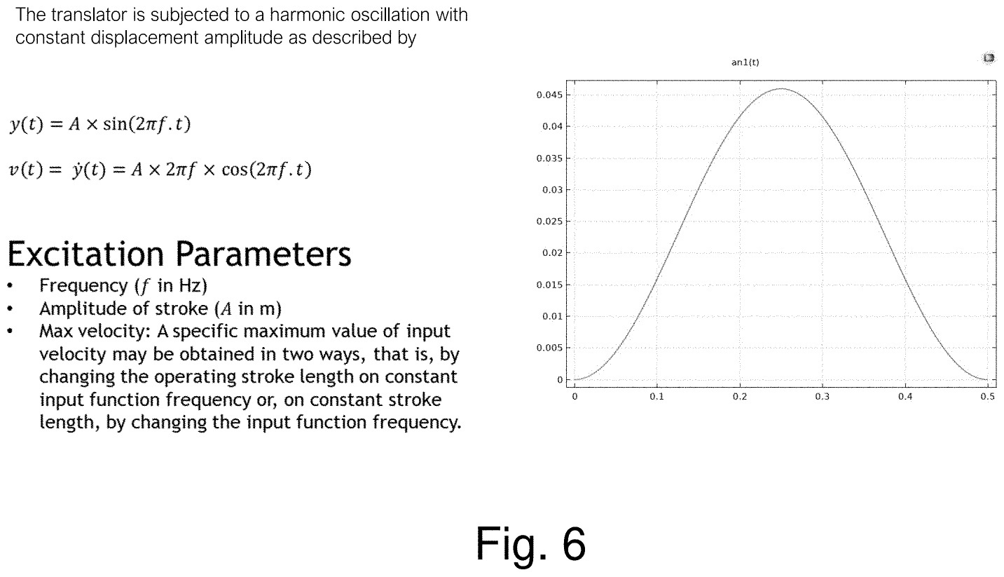

FIG. 6 illustrates input waveform(s) used for the mathematical modeling of the linear generator 100. The displacement with respect to time y(t) is specified by A×sin (2πf.t) and the corresponding velocity of the input waveform v(t)=A×2πf×cos (2πf.t).

Specifically, if the flux through N loops of wire changes by dΦ_{B} in time dt, the induced electromagnetic field is:

$$ɛ = - N \frac{d {Φ}_{B}}{dt} . Faraday ' s law of induction .$$

Where the magnetic flux is:

Φ_{b}=∫\vec{B}·d\vec{A}.

Therefore, ways to induce an electromagnetic field include changing the magnitude of the flux B within a coil or changing the area of the loop in the field. For instance, by changing the orientation of the coil in the flux B field by spinning the coil, such that the effective area of the coil perpendicular to the flux B field changes with time. That is, in a rotary type generator the induced electromagnetic field increases proportionally to the motor's angular velocity and will therefore be zero when the motor is not turning. Whereas, in a linear type generator, the induced electromagnetic field is proportional to the linear velocity of the coil(s) moving through the flux B field. That is, in a linear generator the maximum induced electromagnetic field will correspond to maximum velocity, which occurs at the minimum displacement and the minimum induced electromagnetic field will correspond to minimum velocity, which occurs at the maximum displacement or stoke length.

If the input frequency is fixed, the maximum velocity may be increased by increasing the length of the stroke. If the stroke length is fixed, the maximum velocity may be increased by increasing the frequency of the stroke. Therefore, the output power of the linear generator may be modified by adjusting the stroke length or stoke frequency, either alone or in combination.

In some embodiments, the magnitude of an output voltage of the linear generator may be increased by increasing a stroke length of the linear generator. In other embodiments, the magnitude of the output voltage of the linear generator may be increase by increasing an excitation frequency of the linear generator. In certain embodiments, the magnitude of the output voltage of the linear generator may be increase by increasing both the stroke length and the excitation frequency of the linear generator.

In some embodiments, the 3-phase winding of the linear generator 100 may be connected in a star (e.g., a wye (Y) configuration). In certain embodiments, the star configuration may further comprise a neutral connection to a common star point. In another embodiment, the 3-phase winding of the linear generator 100 may be connected in a delta (Δ) configuration.

In certain embodiments, the linear generator may be configured to provide three alternating current outputs that are about 120 degrees out of phase with each other. In other embodiments, the linear generator may be configured as a 2-phase generator. For example, the linear generator may be configured to provide two alternating current outputs that are about 90 degrees out of phase with each other. In one embodiment, the linear generator may be configured as a single-phase generator. For example, the linear generator may be configured to provide a line to line voltage of about 240V and/or phase to neutral voltage of about 120V.

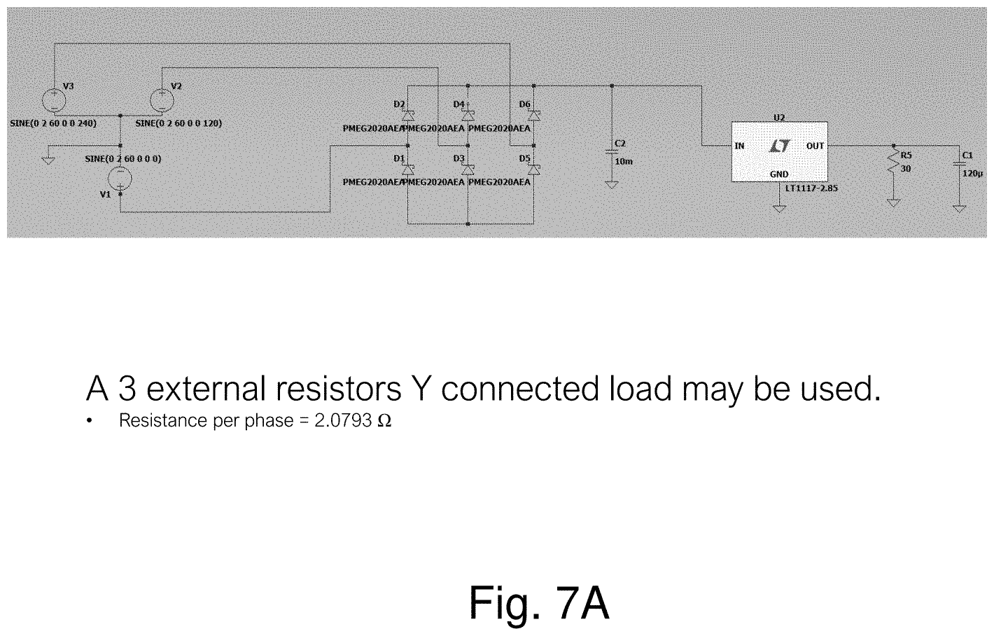

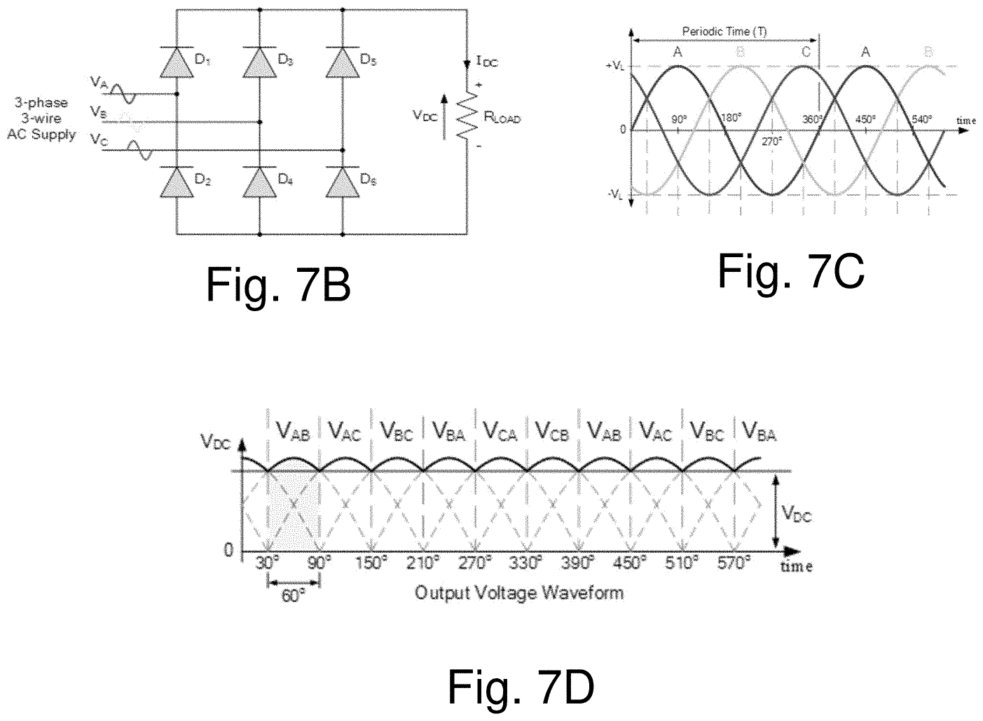

FIG. 7A illustrates a full-wave three-phase rectification circuit that may be user to convert a 3-phase Alternating Current (AC) output of a linear generator to a Direct Current (DC) regulated Voltage. The circuit includes a plurality of general application Schottky barrier rectifiers or diodes D1-D6. A Schottky diode or Schottky barrier diode is characterized by a very low forward voltage drop and a very fast switching action. In the illustrative embodiment of FIG. 7A the plurality of Schottky barrier rectifiers D1-D6 are configured as a full-wave three-phase rectification circuit and are PMEG2020AEAs, which is a Planer Maximum Efficiency General Application (MEGA) Schottky barrier rectifier in a SOD323 (SC-76) package having a 20V (reverse voltage), 2A (forward current), and very low VF (voltage forward) drop.

In certain embodiments, a linear regulator may be coupled to the output of the full-wave three-phase rectification circuit. In the illustrative embodiment of FIG. 7A the linear regulator is a LT1117-2.85 which is a 800 mA high-efficiency, low dropout, DC/DC converter intended for low voltage rectification in switch mode power supplies and the like having a fixed regulated output of 2.85V. In some embodiments, the low dropout positive voltage regulator may have a fixed 3.3 V or 5.0 V output voltage. In other embodiments, the output of the low dropout positive regulator may be adjustable.

With additional reference to FIGS. 7B-7D. FIG. 7B illustrates a 3-phase bridge rectifier circuit connected to a 3-phase 3 wire AC supply as illustrated in FIG. 7C. In 3-phase power rectifiers, conduction always occurs in the most positive diode and the corresponding most negative diode. Thus, as the three phases rotate across the rectifier terminals, conduction is passed from diode to diode. Then each diode conducts for 120 degrees (one-third) in each supply cycle but as it takes two diodes to conduct in pairs, each pair of diodes will conduct for only 60 degrees (one-sixth) of a cycle at any one time. FIG. 7D illustrates the corresponding six half-waves of the rectified DC output for the circuit of FIG. 7B. Note that there is no common connection between the rectifiers input and output terminals. Therefore, the 3-phase power rectifier can be fed by a star connected or a delta connected supply.

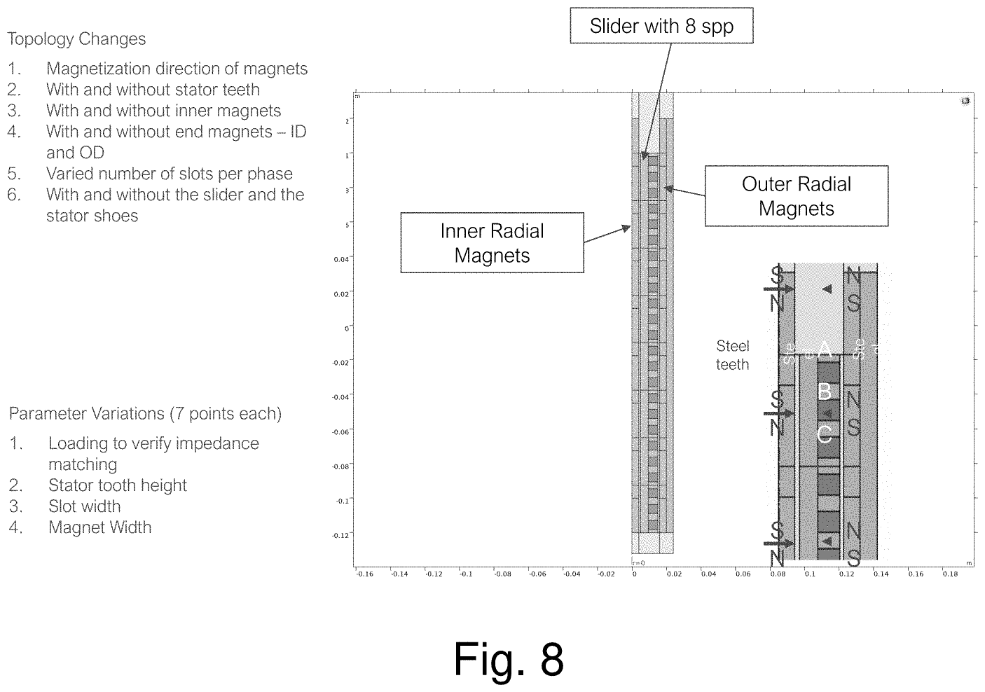

FIG. 8 illustrates various topology changes and parameter variations that were simulated using finite element analysis during the performance evaluation of the linear generator 100. For instance, topology changes may include one or more of the magnetization direction of the magnets, with and without stator teeth, with and without the inner magnets, with and without end cap magnets, varying the inner diameter and the outer diameter, varying the number of slots per phase, with and without the slider, with and without the stator shoes, and the like. Whereas, parameter variations may include one or more of varying the loading to establish the impedance matching, varying the stator tooth height, the slot width, and the magnet width and the like for a number of different simulation points, for instance seven. In other embodiments, variations of a linear motion generator, a reciprocating linear motor, and/or a regenerative shock absorber may be provided using some or all of the principles described above.

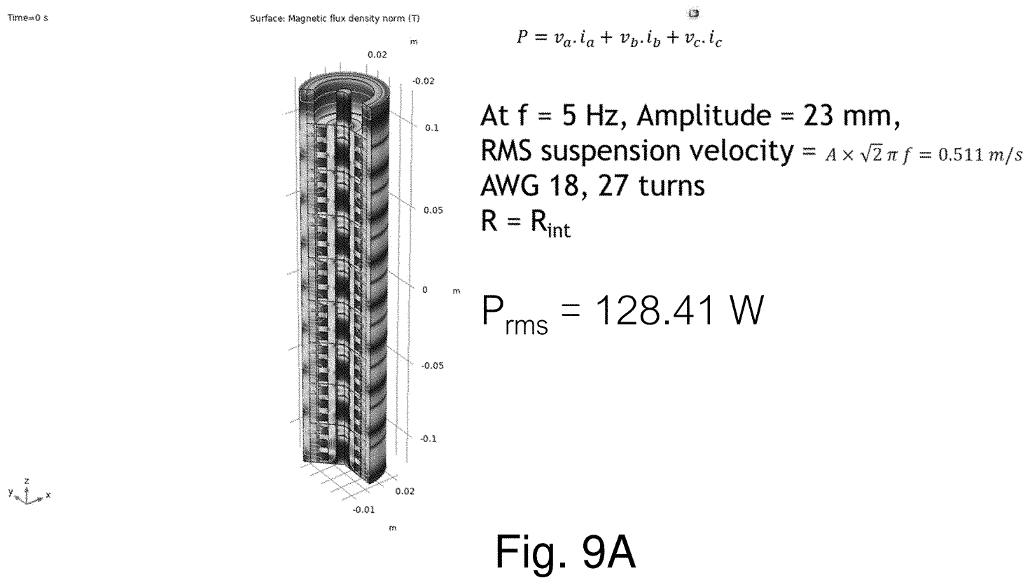

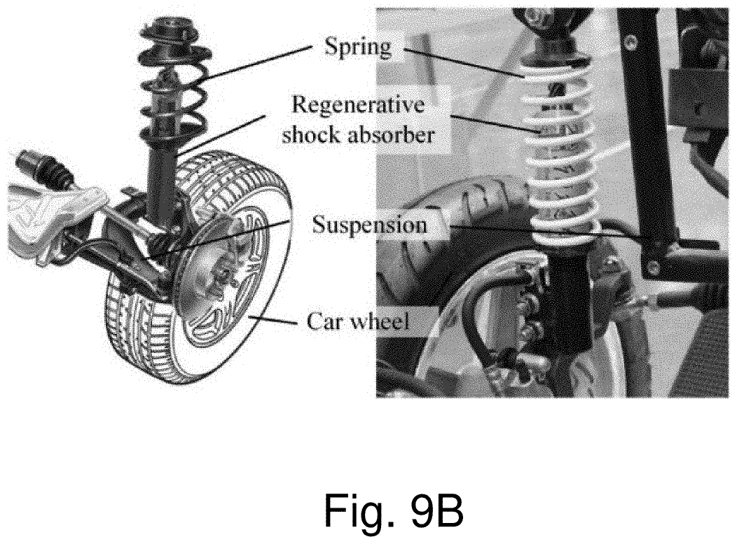

FIG. 9A illustrates surface magnetic flux density of certain embodiments. FIG. 9A illustrates surface magnetic flux density and corresponding simulated power output of a single regenerative shock absorber, as illustrated in FIG. 9B, based on typical excitation values. The application of such a linear generator when used as part of a regenerative shock absorber could reduce the power supply requirements of vehicles in the automotive industry. In the illustrative example of FIG. 9A the root (rms) power output of the regenerative shock absorber is about 130 watts for an excitation frequency of 5 Hz with a stroke amplitude stimulus of 23 mm and a rms stroke or suspension velocity of about 0.5 m/s. The coil winding assembling 102 being in this instance 27 turns of 18 American Wire Gauge (AMG).

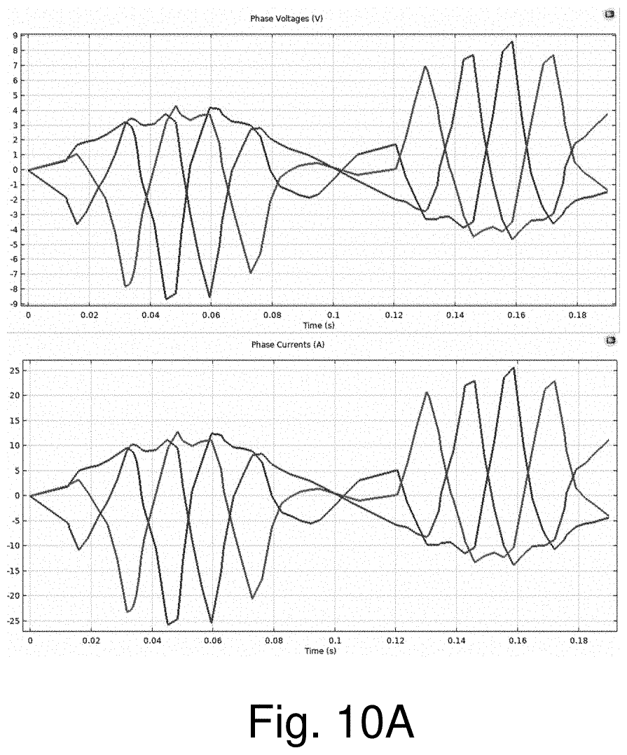

FIG. 10A illustrates typical phase voltage and phase current waveforms for a 3-phase regenerative shock absorber when exited with a stroke amplitude stimulus of 23 mm at 5 Hz (FIG. 10B, top) and a rms stoke or suspension velocity of about 0.5 m/s. Accordingly, as depicted, 1 cycle corresponds to 0.2 seconds. FIG. 10B, bottom illustrates the corresponding instantaneous rms power output in watts for the regenerative shock absorber.

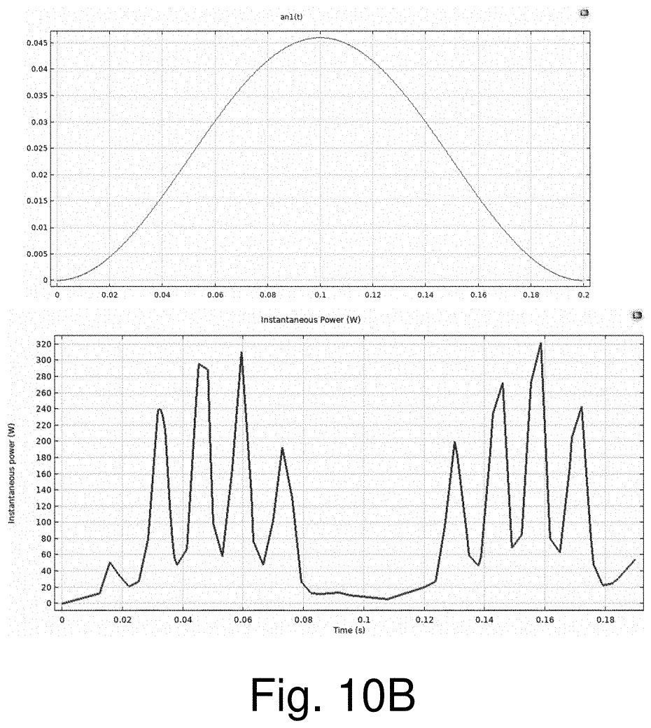

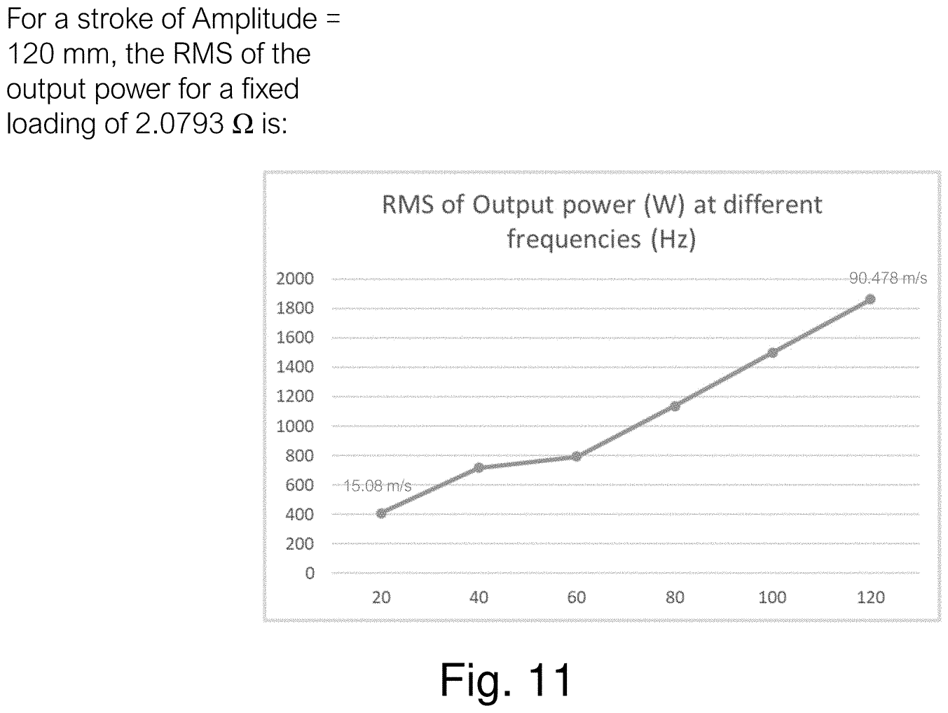

FIG. 11 is a graph illustrating the hypothetical root mean square (rms) power output of the proposed linear generator when used as a regenerative shock absorber for much higher excitation frequencies and stroke amplitudes.

In some embodiments, the internal cylindrical magnets 208 and the external cylindrical magnets 204 of the magnetic assembly 200 of the linear machine 100 may comprise a torque tunnel array of magnets 204, 208 having the same orientation. In certain embodiments the internal cylindrical core of magnets 208 may be replaced with a hollow tube or central core 104 of ferrous material to provide a back-iron path. In one embodiment, the central core 104 may define one or more fluid communication passageways to allow for air or liquid cooling.

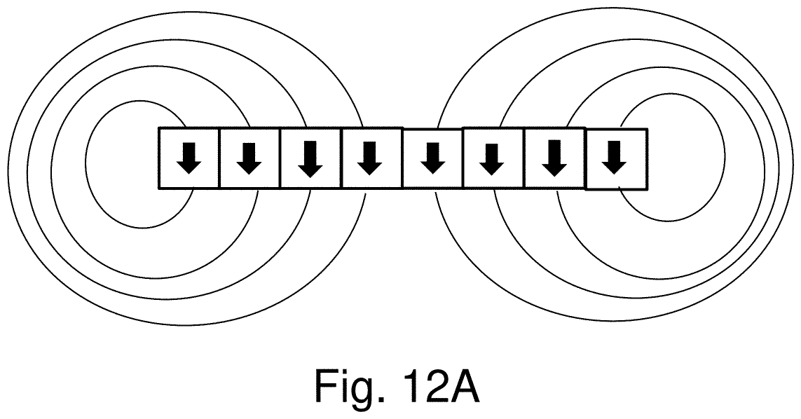

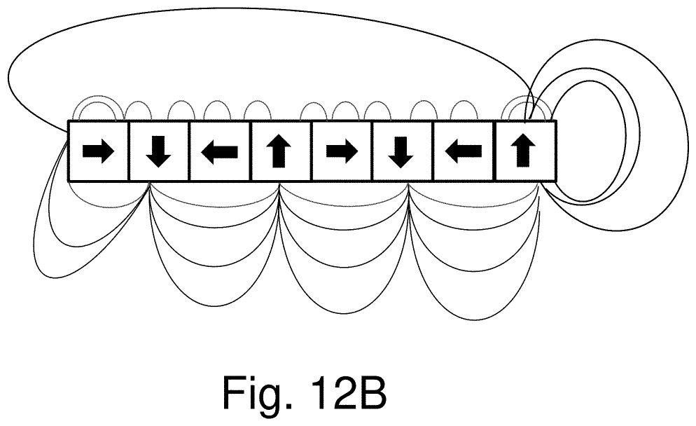

FIG. 12A illustrates a conventional array of eight magnets having the same orientation and their stand-alone flux field.

In other embodiments, the internal cylinder magnets 208 and the external cylindrical magnets 204 of the magnetic assembly 200 of the linear machine 100 may comprise a torque tunnel array of magnets having a cylindrical configuration of alternating magnets, that is a Halbach array of magnets. A Halbach array is a special arrangement of permanent magnets having a spatially rotating pattern of magnetization that increases the magnetic field strength on one side of the array while decreasing the magnetic field strength on the other side.

A Halbach array may not require a ferrous back iron material behind the magnets and aluminum may be used instead of a ferrous back iron material to reduce weight, although the thickness of the aluminum may have to be increased to provide the necessary structural strength. In the following embodiments, although end caps may be shown, such embodiments may be implemented without such end caps.

In certain embodiments the internal cylindrical core of magnets 208 may be replaced with a hollow tube or central core 104 of ferrous material to provide a back-iron path. In one embodiment, the central core 104 may define one or more fluid communication passageways to allow for air or liquid cooling.

FIG. 12B illustrates the corresponding stand-alone flux field of a Halbach array of eight permanent magnets. Specifically, FIG. 12B illustrates a Halbach array of 4 magnets, forming 2 poles or 1 pole pair, which is repeated twice for a total of 8 magnets, forming 4 poles or two pole pairs.

In some embodiments, the linear generator 100 may include an array of permanent magnets having different magnetic orientations, that is a Halbach array, configured to generate a spatially rotating pattern of magnetization. In such an arrangement, the magnetic field strength may be almost doubled on an augmented side and near zero on a diminished side when compared to a conventional array of magnets having the same orientation. In one embodiment, the Halbach array of permanent magnets may include four magnets having different magnetic orientations. In another embodiment, the Halbach array of permanent magnets may include eight magnets having different orientations. Although some of the following embodiments of the linear generator 100 may exclude an end cap(s), these embodiments may be also implemented without or without end cap(s).

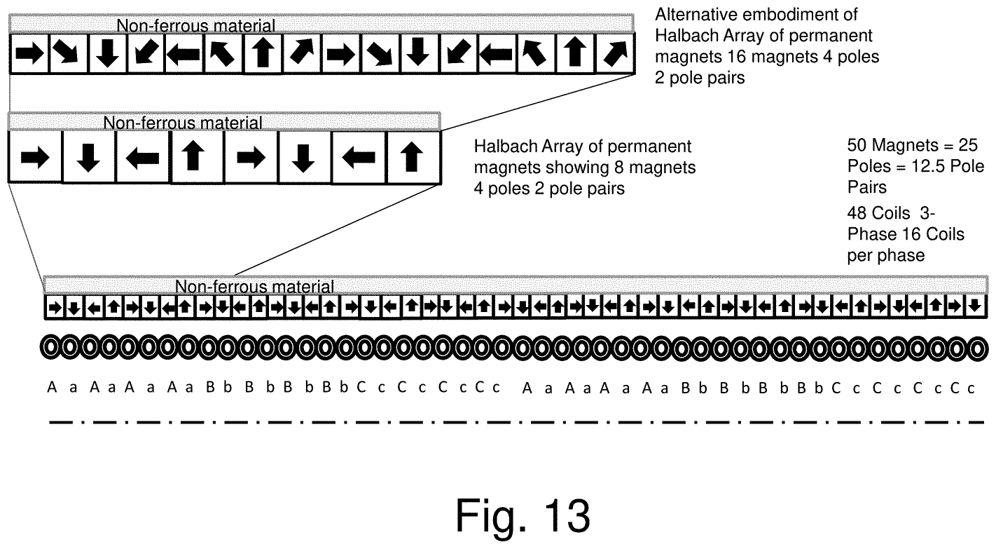

FIG. 13 is a cross section view of two different embodiments of the linear generator 100 illustrating the relationship between a repeating Halbach array of permanent magnets and the corresponding coils 108 of a 3-phase coil winding assembly 102. In one embodiment the Halbach array of permanent magnets may include four permanent magnets having different magnetic orientations and the array may be repeated for the length of the stator of the linear generator 100. For instance, the array of permanent magnets may be repeated about fifteen times along the length of the stator and therefore consist of 60 magnets configured to form 30 poles or 15 pole pairs. The associated 3-phase coil winding assembly 102 may include a sequential sequence of a phase-A coil 108, a phase-B coil 108, and a phase-C coil 108 and the arrangement may be repeated for the length of the armature of the linear generator 100.

In certain embodiments, the coils 108 of the coil winding assembly 102 may be connected in series, parallel, or combinations thereof to match the current and voltage requirements of the system. For instance, the above sequential sequence of coils 108 for the 3-phase coil winding assembly 102 may be repeated 16 times along the length of the coil winding assembly 102 and therefore consist of 48 coils 108, where each phase winding has 16 coils. In one embodiment, there may be a plurality of coils 108 connected in sequence for each phase. For instance, there may be 8 phase-A coils 108, followed by 8-phase-B coils 108, followed by 8-phase C coils 108, and then the sequence may be repeated for the length of the coil winding assembly 102. For instance, the sequence may be repeated twice. In the illustrative embodiment of FIG. 13, the total number of permanent magnets in the fifteen Halbach arrays is 60, of which about 50 may be substantially aligned with the 48 coils 108 of the coil winding assembly 102 at any one time.

In another embodiment, the Halbach array of permanent magnets may include eight magnets having different magnetic orientations and the array may be repeated for the length of the stator of the linear generator 100. For instance, the array of permanent magnets may be repeated about fifteen times along the length of the stator and therefore consist of 120 magnets configured to form 30 poles or 15 pole pairs. The associated 3-phase coil winding assembly 102 may include 48 coils 108 configured to form 3-phase windings, where each phase winding has 16 coils. In this embodiment the total number of permanent magnets in the fifteen Halbach arrays would be 120, of which about 100 may be substantially aligned with the 48 coils 108 of the coil winding assembly 102 at any one time.

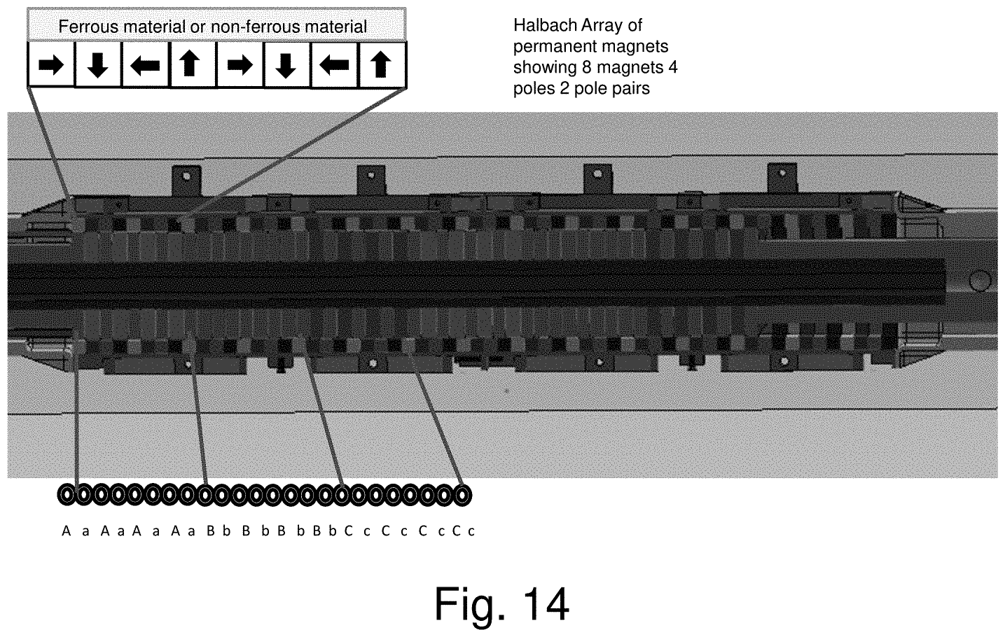

FIG. 14 illustrates a detailed cross section view of the embodiment of FIG. 13 including the region of the Halbach arrays the extend beyond the length of the coil winding assembly 102. In the illustrated example of FIG. 14 there are 60 Halbach magnets and 48 coils 108, and the coil winding assembly 102 is at one end of its travel.

In some embodiments, the linear generator 100 may include a magnetic end cap comprising of a plurality of magnets coupled to one end of the magnetic torque tunnel to form a closed tunnel end. In certain embodiments, the end cap may include a Halbach array of permanent magnets.

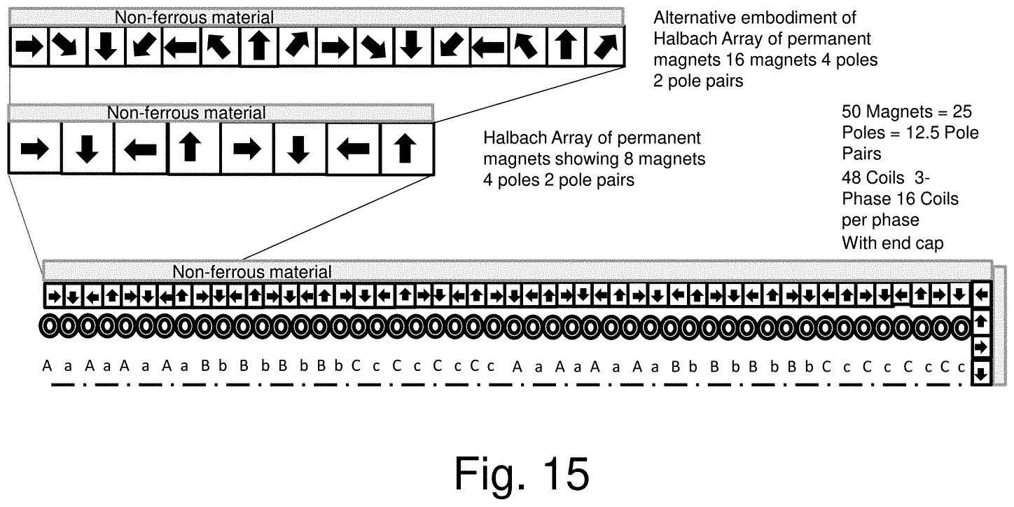

FIG. 15 illustrates a cross section view of the embodiment of FIG. 13 including an end cap having a Halbach array of permanent magnets. In certain embodiments the end cap may include ferrous material. In another embodiment, the plurality of magnets coupled to the magnetic tunnel are each oriented, such that their similar poles, for instance their north poles, are configured to face inwards. In yet another embodiment, the end cap may include one or more magnets oriented, such that their similar poles, for instance their north poles, are configured to face inwards.

In some embodiments, linear generator(s) 100 may be stacked by means of a fastening feature to create a linear generator 100 of a desired length and/or power. For instance, linear generators 100 may be connected in parallel to create a combined linear generator 100 of the desired power for an electrical system. In another instance, linear generators 100 may be connected in series to create a combined linear generator of the desired power. In certain embodiments, a full-wave three-phase rectification circuit may be employed with each of the linear generators 100 to convert the time-varying (AC) winding voltages to a constant (DC) voltage for the electrical system.

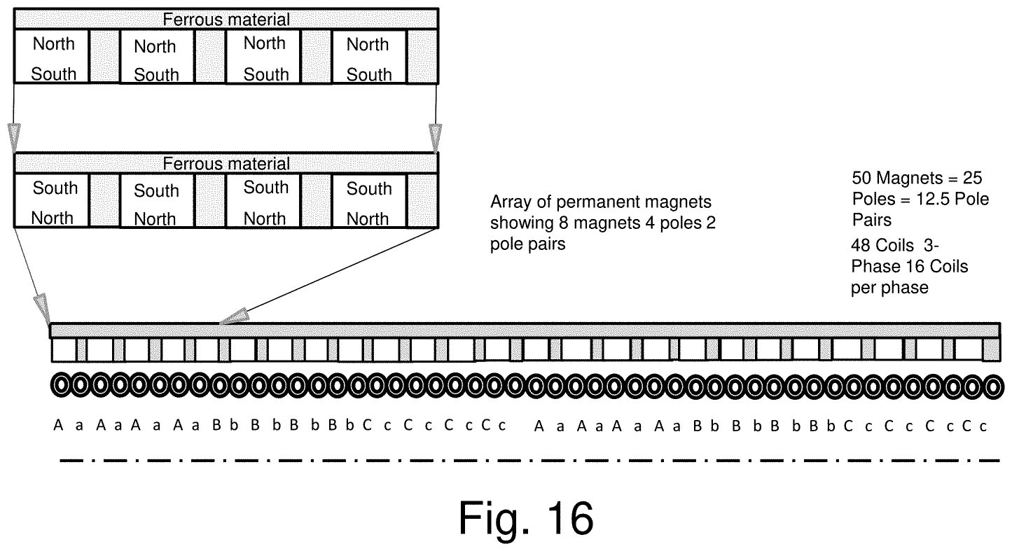

In some embodiments, the linear generator may include a plurality of magnets positioned within an exterior retaining wall of a tube about a longitudinal axis of the tube. The plurality of magnets may have their similar magnetic poles pointing towards the longitudinal axis and separated by ring spacers 206, 210 of ferrous material and/or alternative poles. FIG. 16 illustrates one such embodiment. A linear generator 100 having a ferrous ring spacer 206, 210 acting as an alternative pole may use less magnetic material than a conventional array of magnets having the same orientation or the previously described Halbach embodiments. For instance, a ratio of 70% magnetic material to 30% ferrous ring spacer 206, 210, by stator length, may be used. Such embodiments are otherwise similar or analogous to the previously described Halbach embodiments.

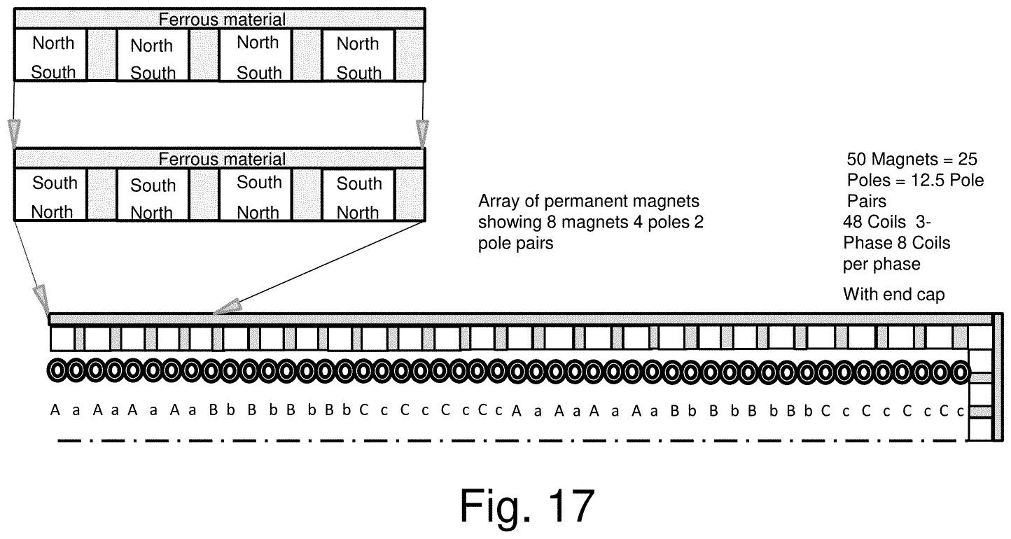

FIG. 17 illustrates a cross section view of the linear generator of FIG. 16 including an end cap having a plurality of magnets with their similar magnetic poles facing inwards towards the interior of the linear generator and separated by spaces of ferrous material.

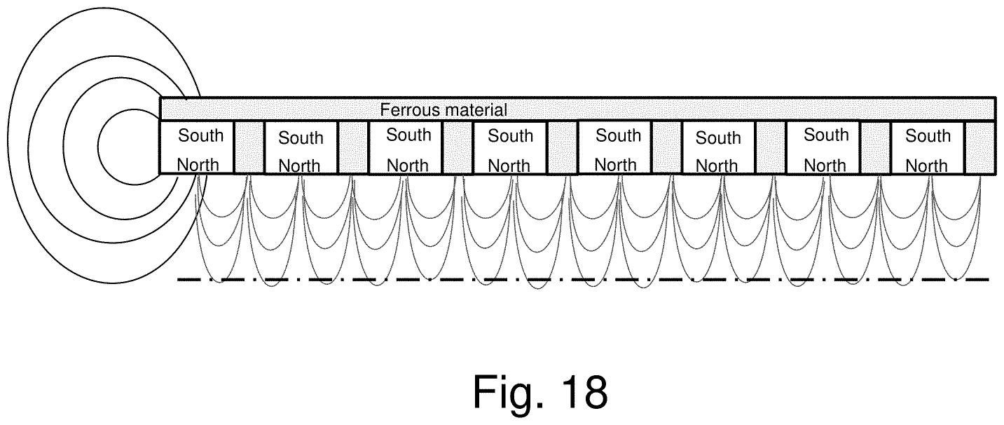

FIG. 18 illustrates the stand-alone flux field of a portion of the linear generator of FIG. 16. Each of the magnets and spacers form a pole pair, such that the magnetic flux force travels from a magnetic pole pointing towards the longitudinal axis to a magnetic pole pointing away from the longitudinal axis, by means of an adjacent spacer of ferrous material and an adjacent portion of the back iron material.

In some embodiments, a method of producing electric power with a linear machine may include positioning a magnetic torque tunnel about a central longitudinal axis of the linear machine. In certain embodiments, the magnetic torque tunnel may be defined by an outer core assembly having a plurality of exterior permanent magnets positioned within and coupled to a retaining wall of a tube and an interior core assembly having a plurality of interior permanent magnets positioned about and coupled to a central core, such that the like magnetic poles of the exterior permanent magnets and the interior permanent magnets face each other forming a magnetic torque tunnel configured to concentrate the flux density of a magnetic field. In one embodiment, the method of producing electric power further includes positioning a coil winding assembly within the magnetic torque tunnel, the coil winding assembly configured to slidably move back-and-forth along a central axis of the magnetic torque tunnel. The coil winding assembly having a plurality of coils configured to drive current through an external load when the plurality of coils moves through the magnetic field of the magnetic torque tunnel. In another embodiment, the method of producing electrical power also including coupling a longitudinal shaft to the coil winding assembly and mechanically coupling the longitudinal shaft to a reciprocating power source configured to drive the coil winding assembly back-and-forth within the magnetic torque tunnel along the central longitudinal axis of the linear machine.

### A First Application

For vehicles, the main focus of energy harvesting is braking energy, heat loss recovery, and vibration energy. One application for the embodiments of the linear generator 100 described herein may be as part of a regenerative shock absorber that uses the vibrations absorbed by the suspension of a vehicle driving on a road surface to generate power. In contrast, to a conventional shock absorber that merely dissipates vibration energy in the form of heat a regenerative shock absorber is a type of shock absorber that converts vibration energy into useful energy, such as electricity. In an electric or hybrid electric vehicle, the electricity generated by a regenerative shock absorber may be diverted to the vehicle's powertrain to increase the battery life of the vehicle, whereas in a conventional vehicle, the electricity may be used to power accessories such as the vehicle's air conditioning, and the like. Data suggests that electromagnetic regenerative shock absorbers can recover between about 20% and about 70% of the energy lost in a conventional suspension system. For instance, research studies have indicated that between about 100 W and about 400 W may be harvested for a typical passenger vehicle traveling at a speed of about 60 mph on a good road surface by such regenerative shock absorber systems.

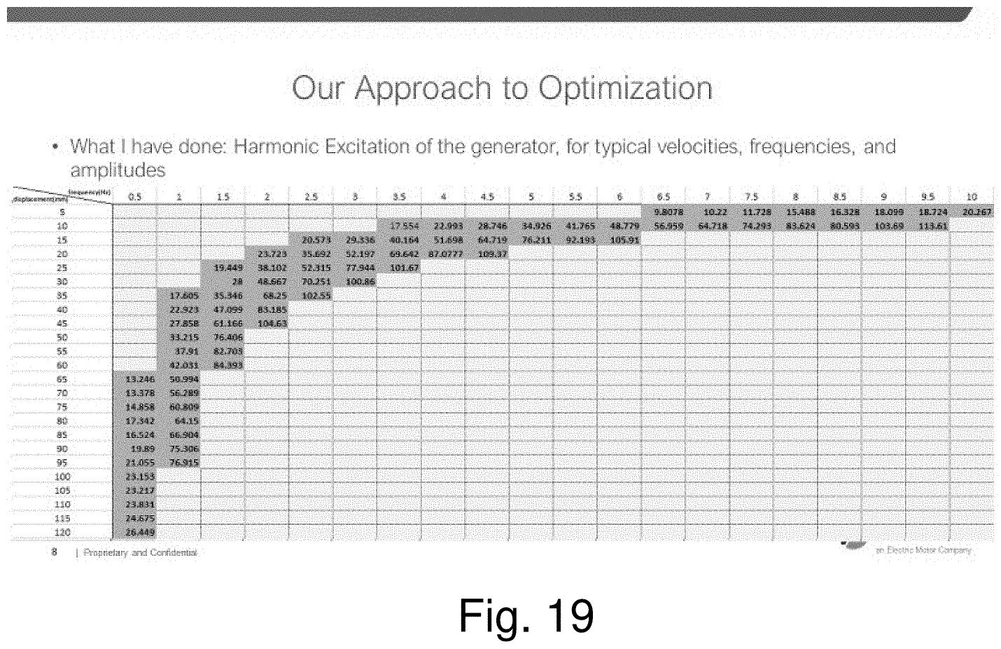

Referring to FIG. 19, various parameters that affect the hypothetical root mean square (rms) power output of the proposed linear generator when used as a regenerative shock absorber are illustrated in a tabula form for purposes of example. In practice parameters such as the stroke amplitude, linear velocity, and excitation frequency of the regenerative shock absorber are dependent on a number of factors. For instance, the stroke amplitude, linear velocity, and frequency will vary dynamically as the vehicle's suspension reacts to the vehicle's bouncing, pitching, and/or rolling in response to the changing road conditions, such as the road surface, gradient, corners, camber, and the like. Further, these parameters will be dependent on changing driving styles and conditions, such as speed, acceleration, cruising, braking, urban driving, freeway driving, the condition of the road surface, and the like. Even further, these parameters and therefore the power output of the regenerative shock absorber(s) may vary with their location on the vehicle. For instance, whether the regenerative shock absorber is located on a front or rear wheel. As such the power output may also vary dynamically between the front and rear of the vehicle and even between the left front/rear side and the right front/rear side of the vehicle. Yet further, the output of the regenerative shock absorber may be dependent on the vehicle's mass/inertia/category, tire pressure, suspension/comfort. ride setting, and the like. All of which may also vary dynamically.

In practice, it may only be possible to harvest a faction of the potential harvestable power with a regenerative shock absorber before the existing damping characteristics of the vehicle's suspension are affected. In some embodiments, the power output of regenerative shock absorber may be limited so as not to adversely affect the existing damping characteristics of the vehicle's suspension.

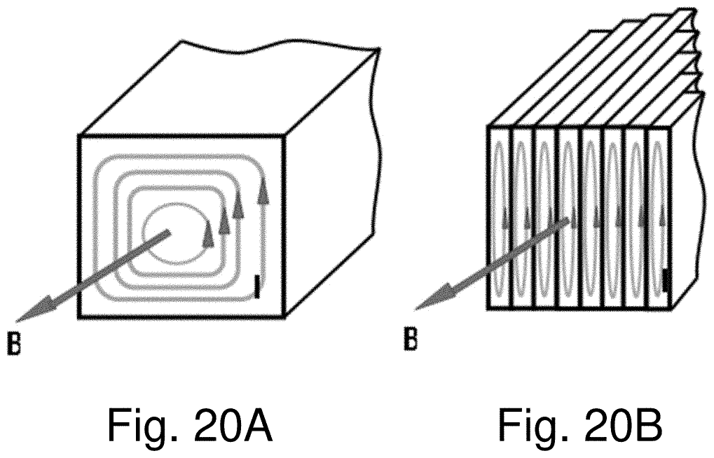

Referring to FIG. 20A, electromagnetic damping is the product of induced eddy currents in a coil having resistance. That is, when a conductive material is subject to a time-varying magnetic flux, eddy currents are generated in the conductor. These eddy currents circulate inside the conductor and generate a magnetic field of opposite polarity as the applied magnetic field. That is, the movement of a current carrying coil in a magnetic field is opposed by damping forces due to the interaction of the permanent magnet and induced magnetic field in the coil. Eddy currents can produce significant drag, called magnetic damping, on the motion involved. Referring now to FIG. 20B. In contrast, while an electromagnetic field of opposite polarity is still induced when a slotted or laminated conductive material enters the magnetic field, the damping effect is less because the laminations limit the size of the current loops. Moreover, adjacent laminations have currents in opposite directions, and their affects cancel.

In some embodiments, regenerative shock absorber may be configured to employ a magnetic damping effect. For instance, either or both the stator core and the armature core of the regenerative shock absorber may include ferromagnetic material. In certain embodiments, either or both the stator core and the rotor core may be made of laminated ferromagnetic sheets that have an insulating coating on each side, which are stacked to form a core assembly. The thickness of the laminations is directly related to the level of heat losses produced by the regenerative shock absorber when operating and thereby the damping effect. The thinner the laminations, the less the eddy current losses and the smaller the magnetic damping effect. In certain embodiments, the core(s) may be formed a stack of cold-rolled laminated strips of electrical steel separated by a small airgap. In one embodiment, the thickness of the laminated strips is less than about 2 mm. In certain embodiments, the thickness of the laminated strips is greater than about 2 mm. In another embodiment, the air gap between adjacent laminations is less than about one-half mm thick. The regenerative shock absorber may replace or supplement the coil spring of the vehicle suspension system.

hi certain embodiments, the regenerative shock absorber may be configured to employ the damping effect of the electrical load. Further, the electrical load may be configured to dynamically change in real time in response to changing road conditions, driving style, comfort settings, and the like.

### A Second Application

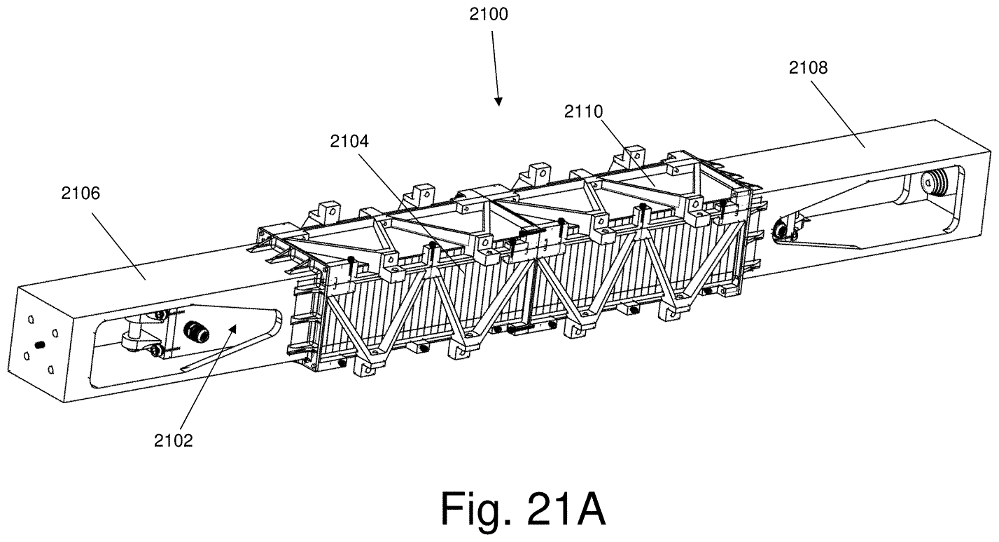

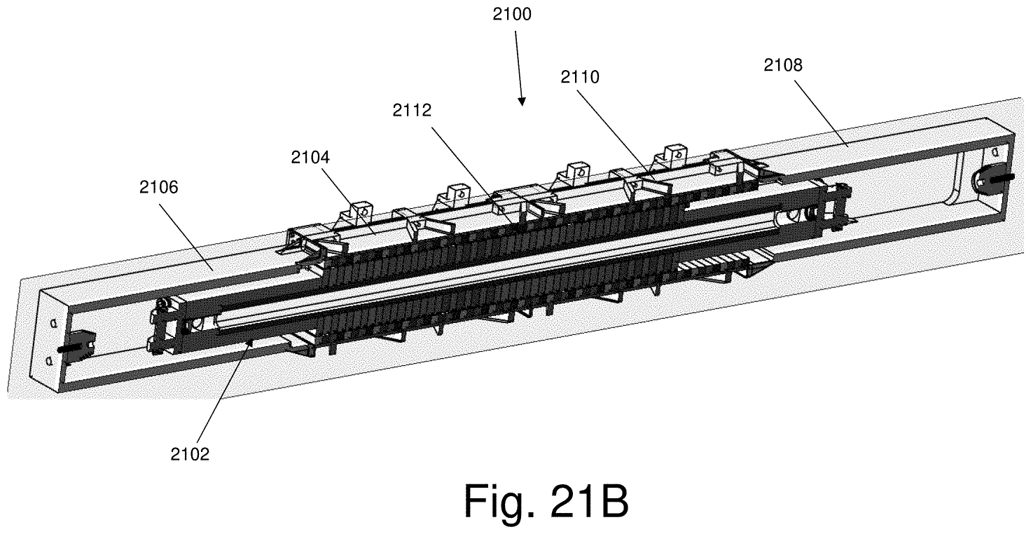

FIGS. 21A and 21B illustrate one embodiment of a linear generator 2100 in perspective and section views, respectively, engineered to survive and perform under the hostile environmental conditions of downhole tooling, such as in critical applications in the Oil & Gas industry. To overcome the limitations and drawbacks of conventional generators and batteries, the linear generator 2100 has been designed to provide consistent and unlimited downstream power to the drill string and downhole logging tools. For instance, the linear generator 2100 may replace expensive and dangerous batteries. In some applications, the linear generator 2100 may provide power to the drill string if mud flow is not present. In certain applications the linear generator 2100 may provide power for electric motors to drive hydraulic pumps and provide torque for wireline tractions wheels. A linear generator 2100 that uses permeant magnets and a torque tunnel configuration will provide more power and operate at a higher efficiency that a conventional linear generator. In some instances, the efficiency of the linear generator 2100 may be greater than 90%.

The linear generator 2100 includes a coil winding assembly 2102, a magnet segment assembly 2104, support frame 2110, coil winding assembly 2112, and segment caps 2106 and 2108. Longitudinal movement of the yoke assembly 2102 within the magnet segment assembly 2104 may operate according to the principles described above to generate electricity.

In some embodiments, the linear generator 2100 may be constructed to operate in high temperature environments. For instance, the linear generator 2100 may be constructed to operate at temperatures of up to above 250 degrees C. In certain embodiments, the linear generator 2100 may be constructed to operate at temperatures in excess of 250 degrees C. In some embodiments, the linear generator 2100 may be configured to operate in high pressure environments. For instance, the linear may be constructed to operate at pressures of up to 25,000 per-square inch (psi). In certain embodiments, the linear generator 2100 may be constructed to operate at pressures in excess of 25,000 psi. The linear generator 2100 may also be constructed to operative in a harsh fluid environment. The linear generator 2100 may also be construed to withstanding high shock. For instance, the linear generator may be configured to withstanding up to 50 g. Even further, the linear generator 2100 may be constructed to operate in these harsh environments for an extend period of time with little or no maintenance. For instance, the linear generator may be constructed to operate in these harsh environments for in excess of 1,000 hours.

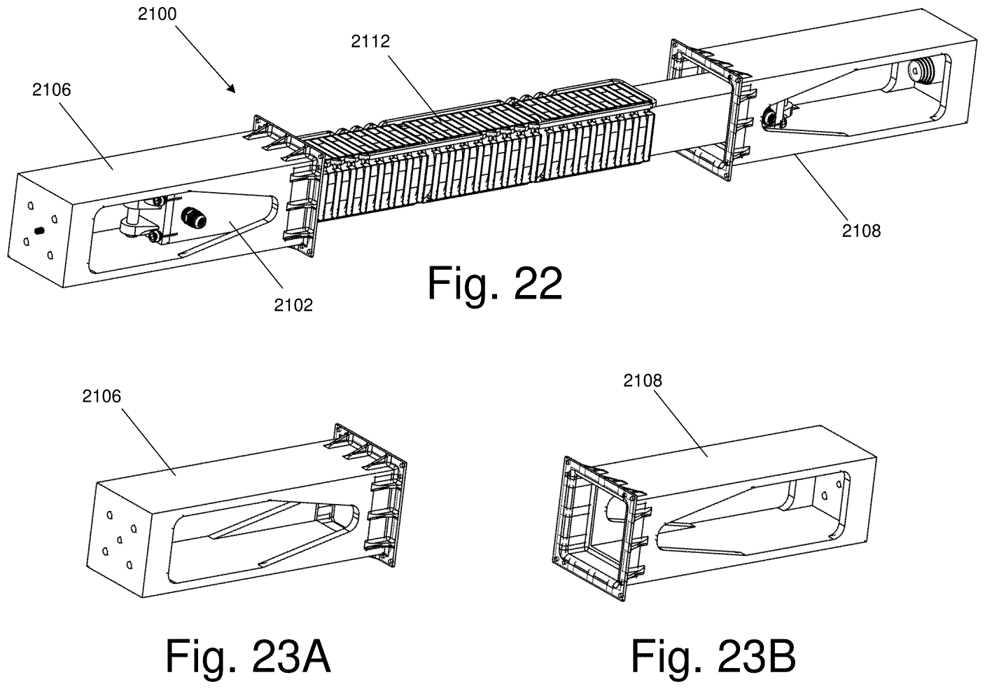

FIG. 22 is a perspective view of the yoke assembly 2102 coupled to the coil winding assembly 2112 having a first end cap and a second end cap with the magnet segment assembly removed.

FIG. 23A is a perspective view of the first end cap 2106 of the yoke assembly of FIG. 22 and FIG. 23B is a perspective view of the second end cap of the yoke assembly of FIG. 22.

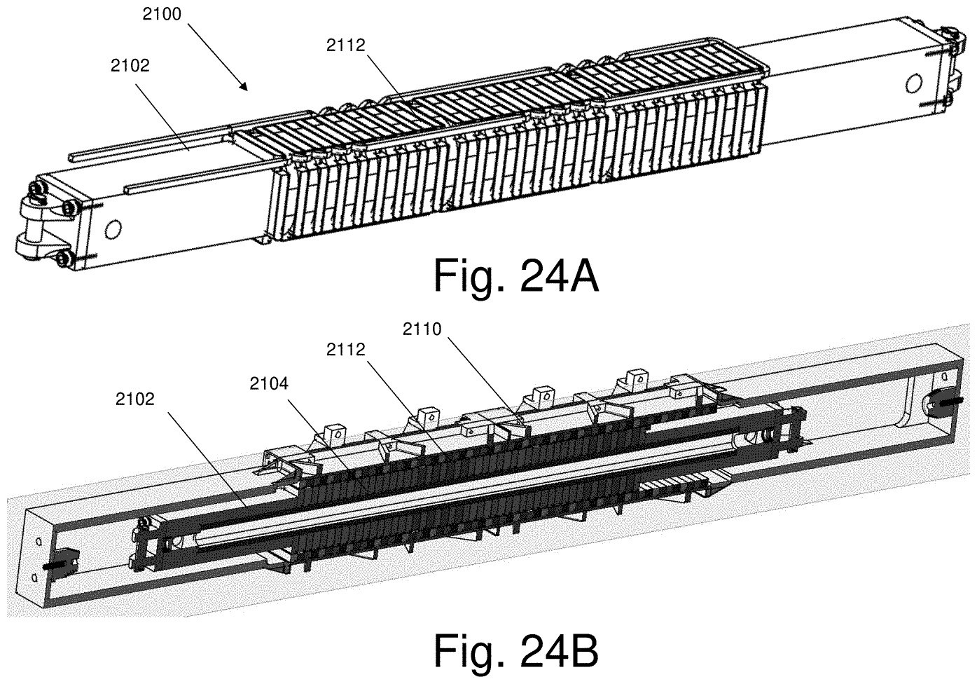

FIG. 24A illustrates the yoke assembly 2102 and coil winding assembly in perspective view. FIG. 24B illustrates a perspective section view of FIG. 24A further including the support frame 2110 and the magnet segment assembly 2104.

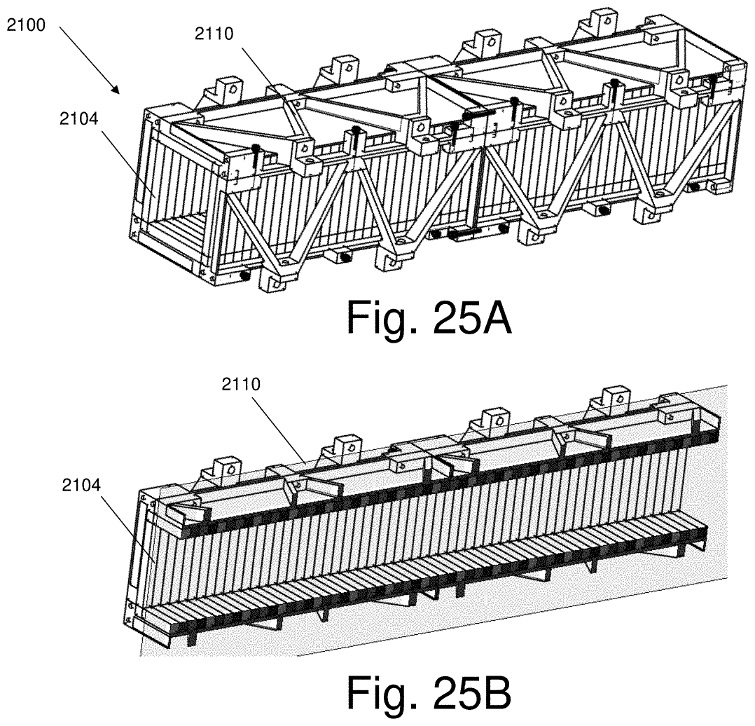

FIGS. 25A and 25B illustrate the magnet segment assembly 2104 and support frame 2110 in perspective and perspective section views, respectively.

The abstract of the disclosure is provided for the sole reason of complying with the rules requiring an abstract, which will allow a searcher to quickly ascertain the subject matter of the technical disclosure of any patent issued from this disclosure. It is submitted with the understanding that it will not be used to interpret or limit the scope or meaning of the claims.

Any advantages and benefits described may not apply to all embodiments of the invention. When the word “means” is recited in a claim element, Applicant intends for the claim element to fall under 35 USC 112(f). Often a label of one or more words precedes the word “means”. The word or words preceding the word “means” is a label intended to ease referencing of claims elements and is not intended to convey a structural limitation. Such means-plus-function claims are intended to cover not only the structures described herein for performing the function and their structural equivalents, but also equivalent structures. For example, although a nail and a screw have different structures, they are equivalent structures since they both perform the function of fastening. Claims that do not use the word “means” are not intended to fall under 35 USC 112(f).

The foregoing description of the embodiments of the invention has been presented for the purposes of illustration and description. It is not intended to be exhaustive or to limit the invention to the precise form disclosed. Many combinations, modifications and variations are possible in light of the above teaching. For instance, in certain embodiments, each of the above described components and features may be individually or sequentially combined with other components or features and still be within the scope of the present invention. Undescribed embodiments which have interchanged components are still within the scope of the present invention. It is intended that the scope of the invention be limited not by this detailed description, but rather by the claims.

What is claimed is:

1. A linear machine comprising:
a magnetic assembly including:
an outer core assembly, the outer core assembly comprising a plurality of exterior permanent magnets positioned within and coupled to a retaining wall of a tube, wherein, wherein adjacent exterior permanent magnets are separated by an exterior ring spacer of ferromagnetic material
an interior core assembly, the interior core assembly comprising a plurality of interior permanent magnets positioned about and coupled to a central core, wherein adjacent interior permanent magnets are separated by an interior ring spacer of ferromagnetic material, and wherein the like magnetic poles of the exterior permanent magnets and the interior permanent magnets face each other forming a magnetic torque tunnel configured to concentrate the flux density of a magnetic field; and
a coil winding assembly positioned around the interior core assembly, wherein the coil winding assembly is sized to be slidably positioned with the magnetic torque tunnel.

2. The linear machine of claim 1, wherein the magnet poles of the plurality of exterior permanent magnets and the magnets poles of the plurality of interior magnets are substantially aligned with each other.

3. The linear machine of claim 1, wherein the exterior permanent magnets form about 70% of a length of the magnetic torque tunnel and the ferromagnetic ring spacer form about 30% of the length of the magnetic torque tunnel.

4. The linear machine of claim 1, wherein the coil winding assembly is configured as 3-phase coil winding assembly and each phase comprises about 16 coils of square copper wire of 1 Standard Wire Gauge, and wherein the magnetic torque tunnel comprises about 15 pole pairs of which about 12.5 pole pairs are aligned with the 48 coils of the 3-phase coil winding assembly at any one time.

5. The linear machine of claim 1, further comprising an end cap core assembly coupled to an axial end of the outer core assembly, the end cap core assembly having a plurality of end cap permanent magnets coupled to an interior face, wherein the magnetic poles of the end-cap permanent magnets face the axial end of the outer core assembly.

6. The linear machine of claim 1, wherein the central core is configured to define one or more fluid communication passageways.

7. The linear machine of claim 1, wherein the coil winding assembly is configured as a stator.

8. The linear machine of claim 1, wherein the coil winding assembly is configured as an armature and mechanically coupled to a longitudinal shaft.

9. A linear machine comprising:
a magnetic assembly including:
an outer core assembly, the outer core assembly comprising a plurality of exterior permanent magnets positioned within and coupled to a retaining wall of a tube, wherein the plurality of exterior permanent magnets are configured to form a plurality of exterior Halbach arrays and each exterior Halbach array comprises four permanent magnets having different magnet orientations, and wherein each exterior Halbach array is separated by an exterior ring spacer of ferromagnetic material;
an interior core assembly, the interior core assembly comprising a plurality of interior permanent magnets positioned about and coupled to a central core, wherein the plurality of interior permanent magnets are configured to form a plurality of interior Halbach arrays and each interior Halbach array comprises four permanent magnets having different magnet orientations, wherein each interior Halbach array is separated by an interior ring spacer of ferromagnetic material, and wherein the like magnetic poles of the exterior Halbach arrays and the interior Halbach arrays face each other forming a magnetic torque tunnel configured to concentrate the flux density of a magnetic field; and
a coil winding assembly positioned around the interior core assembly, wherein the coil winding assembly is sized to be slidably positioned with the magnetic torque tunnel.

10. The linear machine of claim 9, wherein the magnet poles of the plurality of exterior Halbach arrays and the magnets poles of the plurality of interior Halbach arrays are substantially aligned with each other.

11. The linear machine of claim 9, wherein each of the exterior Halbach arrays and each of the interior Halbach arrays comprises eight permanent magnets having different magnets orientations.

12. The linear machine of claim 9, wherein the coil winding assembly is configured as 3-phase coil winding assembly and each phase comprises about 16 coils of square copper wire of 1 Standard Wire Gauge, and wherein the magnetic torque tunnel comprises about 15 Halbach arrays having about 60 permanent magnets of which about 50 are aligned with the 48 coils of the 3-phase coil winding assembly at any one time.

13. The linear machine of claim 9, wherein the linear machine is configured as a regenerative shock absorber having a stroke amplitude of about 23 mm, and wherein moving the coil winding assembly relative to the magnetic assembly produces electrical current.

14. The linear machine of claim 9, wherein the linear machine is configured as a regenerative shock absorber and the power output of the regenerative shock absorber is limited so as not to adversely affect an existing damping characteristic of the vehicle's suspension system.

15. The linear machine of claim 9, wherein the linear machine is configured as a regenerative shock absorber and the regenerative shock absorber further comprises a laminated ferromagnetic material configured to generate magnetic damping when subjected to a time-varying magnetic flux.

16. The linear machine of claim 15, wherein the thickness of the laminations is greater than about 2 mm.

17. A linear machine comprising:
a magnetic assembly including:
an outer core assembly, the outer core assembly comprising a plurality of exterior permanent magnets positioned within and coupled to a retaining wall of a tube, wherein the plurality of exterior permanent magnets are configured to form a plurality of exterior Halbach arrays;
an interior core assembly, the interior core assembly comprising a plurality of interior permanent magnets positioned about and coupled to a central core, wherein the plurality of interior permanent magnets are configured to form a plurality of interior Halbach arrays, wherein the like magnetic poles of the exterior Halbach arrays and the interior Halbach arrays face each other forming a magnetic torque tunnel configured to concentrate the flux density of a magnetic field;
an end cap core assembly coupled to an axial end of the outer core assembly, the end cap core assembly having a plurality of end cap permanent magnets coupled to an interior face, wherein the plurality of end cap permanent magnets are configured to form at least one Halbach array, and wherein the magnetic poles of the at least one end-cap Halbach array face the axial end of the outer core assembly; and
a coil winding assembly positioned around the interior core assembly, wherein the coil winding assembly is sized to be slidably positioned with the magnetic torque tunnel.

18. The linear machine of claim 17, wherein each exterior Halbach array comprises four permanent magnets having different magnet orientations and each interior Halbach array comprises four permanent magnets having different magnet orientations.

19. The linear machine of claim 17, wherein each exterior Halbach array comprises eight permanent magnets having different magnet orientations and each interior Halbach array comprises eight permanent magnets having different magnets orientations.

20. The linear machine of claim 17, wherein the linear machine is configured as a regenerative shock absorber and the regenerative shock absorber further comprises an electrical load having an impedance configured to dynamically vary in real time.
